(19) United States
(12) Patent Application Publication
(10) Pub. No.: US 2022/0391737 A1
(43) Pub. Date: Dec. 8, 2022

(54) EVALUATION DEVICE, EVALUATION METHOD, AND RECORDING MEDIUM

(71) Applicant: Panasonic Intellectual Property Management Co., Ltd., Osaka (JP)

(72) Inventors: MIKIO USHIODA, Osaka (JP); NOBUO HARA, Osaka (JP)

(21) Appl. No.: 17/664,418

(22) Filed: May 22, 2022

(30) Foreign Application Priority Data
Jun. 3, 2021 (JP) 2021-093865

(51) Int. Cl. G06N 7/00; G06K 9/62

(52) U.S. Cl. CPC G06N 7/005; G06K 9/6278; G06K 9/6215

(57) ABSTRACT

An evaluation device is a device that evaluates, by Bayesian optimization, an unknown characteristic point corresponding to a candidate experimental point based on a known characteristic point corresponding to an experimented experimental point, the device including: a reception controller that acquires experimental result data indicating the experimented experimental point and the known characteristic point, objective data indicating an optimization objective, and constraint-condition data indicating a constraint condition; an evaluation value calculator that calculates an evaluation value of an unknown characteristic point based on the experimental result data, the objective data, and the constraint-condition data; and an evaluation value output unit that outputs the evaluation value, in which the evaluation value calculator gives weighting according to a degree of compatibility of the constraint condition to an evaluation value for at least one objective characteristic.

### BACKGROUND

### 1. Technical Field

The present disclosure relates to a technique for evaluating experimental conditions used for general industrial product development or manufacturing process development.

### 2. Description of the Related Art

In industrial product development or manufacturing process development, it is necessary to control the control factor under optimal conditions so as to meet the requirements of the required objective characteristics. For example, in development of batteries, positive electrode thickness, negative electrode thickness, the number of separators, electrolyte solution ionic conductivity, and the like are set as control factors, and capacity, life, cost, and the like are set as objective characteristics.

If the relationship between control factors and objective characteristics can be expressed by a physical formula, an optimal solution of the control factor can be searched for by a mathematical optimization technique. However, when the relationship is unknown, a set of combination of values of control factors (that is, experimental points) is selected as experimental conditions, and an actual experiment is conducted. As an experimental result, a combination (that is, a characteristic point) of values of objective characteristics corresponding to the experimental point is acquired. By repeating this experiment, an optimal solution of the control factor is searched.

In general, complicated industrial product development or manufacturing process development costs a lot of money or time to execute a single experiment. Therefore, in order to perform efficient development work, it is important to search for an optimal solution with as small number of experiments as possible.

Conventionally, approaches using an experimental design method and a response surface method have been used for searching for the optimal solution. However, these methods require many attempts by the analyst at a stage of creating a prediction model or searching for an optimal solution, and it is difficult to perform quantitative evaluation with a consistent procedure.

In recent years, in the field of machine learning, a data-driven approach using Bayesian optimization has attracted attention (see, for example, PTL 1, NPL 1, and NPL 2). Bayesian optimization is an optimization technique that assumes Gaussian process as a mathematical model that expresses a correspondence relationship between input and output. Every time an experimental result is obtained, a predictive distribution of characteristic points is calculated for each experimental point having been set. Based on the predictive distribution of each characteristic point, an evaluation criterion called acquisition function is used to select an optimal next experimental condition. This makes it possible to perform quantitative evaluation regardless of the skill of analyst, and also possible to contribute to automation of the optimal solution search work.

### CITATION LIST

### Patent Literature

PTL 1: Unexamined Japanese Patent Publication No. 2019-113985

### Non-Patent Literature

NPL 1: M. Emmerich, A. Deutz, J. W. Klinkenberg, “The computation of the expected improvement in dominated hypervolume of Pareto front approximations,” Repport Technique, Leiden University, Vol. 34, 2008.
NPL 2: M. Abdolshah, A. Shilton, S. Rana, S. Gupta, S. Venkatesh, “Expected Hypervolume Improvement with Constraints,” International Conference on Pattern Recognition (ICPR), 2018.

### SUMMARY

An evaluation device according to one aspect of the present disclosure is an evaluation device that evaluates, by Bayesian optimization, an unknown characteristic point corresponding to a candidate experimental point based on a known characteristic point corresponding to an experimented experimental point, the evaluation device including: a first receiver that acquires experimental result data indicating the experimented experimental point and the known characteristic point; a second receiver that acquires objective data in which the unknown characteristic point indicates one or a plurality of objective characteristics, and at least one objective characteristic has an optimization objective and indicates the optimization objective; a third receiver that acquires constraint-condition data indicating a constraint condition given to the at least one objective characteristic; a calculator that calculates an evaluation value of the unknown characteristic point based on the experimental result data, the objective data, and the constraint-condition data; and an output unit that outputs the evaluation value, in which the calculator gives weighting according to a degree of compatibility of the constraint condition to an evaluation value for the at least one object characteristic.

An evaluation method according to one aspect of the present disclosure is an evaluation method for an evaluation device to evaluate, by Bayesian optimization, an unknown characteristic point corresponding to a candidate experimental point based on a known characteristic point corresponding to an experimented experimental point, the evaluation method including: first receiving of acquiring experimental result data indicating the experimented experimental point and the known characteristic point; second receiving of acquiring objective data in which the unknown characteristic point indicates one or a plurality of objective characteristics, and at least one objective characteristic has an optimization objective and indicates the optimization objective; third receiving of acquiring constraint-condition data indicating a constraint condition given to the at least one objective characteristic; calculating an evaluation value of the unknown characteristic point based on the experimental result data, the objective data, and the constraint-condition data; and outputting the evaluation value, in which in the calculating, weighting according to a degree of compatibility of the constraint condition is given to an evaluation value for the at least one object characteristic.

A recording medium according to one aspect of the present disclosure is a non-transitory recording medium that stores a program for evaluating, by Bayesian optimization, an unknown characteristic point corresponding to a candidate experimental point based on a known characteristic point corresponding to an experimented experimental point, in which when executing the program, a computer executes first receiving of acquiring experimental result data indicating the experimented experimental point and the known characteristic point, second receiving of acquiring objective data in which the unknown characteristic point indicates one or a plurality of objective characteristics, and at least one objective characteristic has an optimization objective and indicates the optimization objective, third receiving of acquiring constraint-condition data indicating a constraint condition given to the at least one objective characteristic, calculating an evaluation value of the unknown characteristic point based on the experimental result data, the objective data, and the constraint-condition data, and outputting the evaluation value, and in the calculating, weighting according to a degree of compatibility of the constraint condition is given to an evaluation value for the at least one object characteristic.

### BRIEF DESCRIPTION OF THE DRAWINGS

FIG. 1 is a view for explaining a schematic operation of an evaluation device according to an exemplary embodiment;

FIG. 2 is a view illustrating an example in which each candidate experimental point and each characteristic point according to the exemplary embodiment are represented by a graph;

FIG. 3 is a view illustrating a configuration of an evaluation device according to the exemplary embodiment;

FIG. 4 is a block diagram illustrating a functional configuration of an arithmetic circuit according to the exemplary embodiment;

FIG. 5 is a view illustrating an example of an acceptance image displayed on a display for accepting input of setting information according to the exemplary embodiment;

FIG. 6 is a view illustrating an example of control factor data according to the exemplary embodiment;

FIG. 7 is a view illustrating an example of objective data and constraint condition data according to the exemplary embodiment;

FIG. 8A is a view illustrating an example of a standard range according to the exemplary embodiment;

FIG. 8B is a view illustrating another example of the standard range according to the exemplary embodiment;

FIG. 9 is a flowchart illustrating a processing operation of the evaluation device according to the exemplary embodiment;

FIG. 10A is a view illustrating an example of candidate experimental point data according to the exemplary embodiment;

FIG. 10B is a view illustrating another example of the candidate experimental point data according to the exemplary embodiment;

FIG. 11 is a view illustrating an example of experimental result data according to the exemplary embodiment;

FIG. 12 is a view for explaining processing by an evaluation value calculator according to the exemplary embodiment;

FIG. 13 is a view illustrating an example of predictive distribution data according to the exemplary embodiment;

FIG. 14A is a view illustrating an example of an improvement region according to the exemplary embodiment;

FIG. 14B is a view illustrating another example of the improvement region according to the exemplary embodiment;

FIG. 15A is a view for explaining a calculation method for a volume of the improvement region according to the exemplary embodiment;

FIG. 15B is a view illustrating an example in which an entire characteristic space is divided into a plurality of small regions according to the exemplary embodiment;

FIG. 15C is a view illustrating an example of a lower end point and an upper end point of the small region according to the exemplary embodiment;

FIG. 16 is a view illustrating an example of evaluation value data according to the exemplary embodiment;

FIG. 17 is a view illustrating an example of a standard range and a management range according to a first modification of the exemplary embodiment;

FIG. 18 is a view for explaining processing by an evaluation value calculator according to a second modification of the exemplary embodiment;

FIG. 19 is a view illustrating an example of a minimum distance according to the second modification of the exemplary embodiment;

FIG. 20 is a view illustrating an example of minimum distance data according to the second modification of the exemplary embodiment; and

FIG. 21 is a view illustrating an example of evaluation value data according to the second modification of the exemplary embodiment.

### DETAILED DESCRIPTIONS

(Findings that have Become Basis of Present Disclosure)

The inventor of the present invention has found a problem that application scenes are limited regarding PTL 1, NPL 1, and NPL 2 described in the section of “Description of the Related Art”. Specifically, the inventor of the present invention has found that the following problems occur in the evaluation device using the methods described in these literatures.

There are several techniques proposed related to multi-objective Bayesian optimization for simultaneously optimizing a plurality of objective characteristics. For example, NPL 1 discloses an optimal solution search principle and a specific calculation method of expected hypervolume improvement (EHVI), which is a type of multi-objective Bayesian optimization. This makes it possible to perform quantitative evaluation of optimal solution search even when there are a plurality of objective characteristics desired to optimize.

In industrial product development or manufacturing process development, there is a case where a standard range is provided as a constraint condition regarding the value of the objective characteristic. For example, the standard range is “the battery capacity is desired to fall within the standard range of 1850 [mAh] to 1950 [mAh]”, “with 3 years as the minimum value, the longer the life is, the better it is (that is, the minimum value of the standard range of the life is 3 years, and the maximum value is +∞)”, or the like. When the conventional Bayesian optimization is applied in a case where there is a standard range, there is a possibility that search has a poor calculation efficiency or a search proceeds to another region that is not the optimal solution.

Therefore, there are also some techniques proposed related to constrained Bayesian optimization. For example, the method of PTL 1 includes, for each candidate experimental point, calculating, from a predictive distribution obtained by Gaussian process regression, a probability of falling within a standard range, extracting only the candidate experimental point whose probability exceeds a certain threshold, and evaluating an acquisition function. This corresponds to the constrained optimization problem.

It is also possible to adopt EHVI to the method of PTL 1 as an acquisition function. However, among the plurality of candidate experimental points, those with the objective characteristic value falling within the standard range can be expected to have significant improvement from the provisional optimal solution, but those with the objective characteristic value that is low in probability of falling within the standard range is excluded from the evaluation target of the acquisition function. Therefore, the technique of PTL 1 in which EHVI is adopted contributes to reduction of the calculation cost, but it is not necessarily possible to search for a true optimal solution.

For example, NPL 2 discloses expected hypervolume improvement with constraints (EHVIC) in which EHVI is extended in a case where there is a constraint condition. The design method of the acquisition function described in NPL 2 comprehensively indexes the probability of falling within the standard range and the improvement amount, and evaluates them for all candidate experimental points. Therefore, there is a high possibility of improving the search efficiency (that is, a true optimal solution is obtained). However, in the design method of the acquisition function described in NPL 2, the objective characteristic desired to be maximized or minimized is different from the objective characteristic desired to fall within the standard range. Therefore, the design method of the acquisition function described in NPL 2 can be applied to an optimization problem such as “the battery capacity is 1850 [mAh] to 1950 [mAh], and it is desired to search for an experimental point that maximizes the life” in the above example. However, the method of NPL 2 cannot be applied to an optimization problem in which a constraint condition such as a standard range is given to an objective characteristic having an objective such as maximization or minimization, such as “it is desired to search for an experimental point that maximizes the life three years or more”.

Therefore, an object of an evaluation device according to one aspect of the present disclosure is to apply Bayesian optimization to an optimization problem in which a constraint condition is given to an objective characteristic having an objective of the optimization problem.

An evaluation device according to one aspect of the present disclosure is an evaluation device that evaluates, by Bayesian optimization, an unknown characteristic point corresponding to a candidate experimental point based on a known characteristic point corresponding to an experimented experimental point, the evaluation device including: a first receiver that acquires experimental result data indicating the experimented experimental point and the known characteristic point; a second receiver that acquires objective data in which the unknown characteristic point indicates one or a plurality of objective characteristics, and at least one objective characteristic has an optimization objective and indicates the optimization objective; a third receiver that acquires constraint-condition data indicating a constraint condition given to the at least one objective characteristic; a calculator that calculates an evaluation value of the unknown characteristic point based on the experimental result data, the objective data, and the constraint-condition data; and an output unit that outputs the evaluation value, in which the calculator gives weighting according to a degree of compatibility of the constraint condition to an evaluation value for the at least one object characteristic.

According to the evaluation device according to one aspect of the present disclosure, it is possible to apply Bayesian optimization to an optimization problem in which a constraint condition is given to an objective characteristic having an objective of the optimization problem.

Specifically, when a calculator calculates the evaluation value of an unknown characteristic point based on experimental result data, objective data, and constraint condition data, weighting according to the degree of compatibility of the constraint condition is given to the evaluation value for at least one objective characteristic. This at least one objective characteristic has an optimization objective. Therefore, it is possible to apply Bayesian optimization to an optimization problem in which a constraint condition is given to an objective characteristic having an objective of the optimization problem. As a result, it is possible to extend the application scene.

The constraint condition is at least one constraint range, the optimization objective includes a first objective of keeping an objective characteristic within any constraint range of the at least one constraint range and a second objective of minimizing or maximizing an objective characteristic, and for each of the at least one objective characteristic, the calculator may calculate the evaluation value by performing weighting processing different from one another among (i) a case where an interval of the objective characteristic used for calculating the evaluation value is out of each of the at least one constraint range, (ii) a case where the interval is within any constraint range of the at least one constraint range, and the optimization objective is the first objective, and (iii) a case where the interval is within any constraint range of the at least one constraint range, and the optimization objective is the second objective. For example, the at least one constraint range may be one standard range, or may be a standard range and a management range. The interval of the objective characteristic is an interval divided by a constraint range, one or more experimental points (more specifically, Pareto point), and the like in a characteristic space expressed by at least one objective characteristic, for example.

Due to this, since the evaluation value calculated for each candidate experimental point is output, the user of the evaluation device can select a candidate experimental point as the next experimental point based on those evaluation values, and use the characteristic point obtained by the experiment using the experimental point, for calculation of the evaluation value of next each candidate experimental point. By repetition of calculation and output of such an experiment and an evaluation value, it is possible to obtain a solution of a candidate experimental point that satisfies an optimization objective of each objective characteristic, that is, an optimal solution.

The evaluation device according to one aspect of the present disclosure performs weighting processing different from one another among in the cases (i) to (iii) for each of at least one objective characteristic. Therefore, regardless of whether the optimization objective of the objective characteristic is the first objective or the second objective, the evaluation value of the candidate experimental point can be appropriately calculated based on Bayesian optimization. That is, the evaluation value of the candidate experimental point can be appropriately calculated based on Bayesian optimization, regardless of whether the optimization objective of the objective characteristic is within the constraint range or maximization or minimization. In the case of (iii), since the interval of the objective characteristic is within the constraint range and the optimization objective is the second objective, unlike the method of NPL 2, the evaluation value can be quantitatively and appropriately calculated even in a case where the objective characteristic whose optimization objective is maximization or minimization has a constraint range as a constraint condition.

As a result, it is possible to apply the present disclosure also to an optimization problem having a constraint range such as a standard range, that is, a constraint condition. That is, it is possible to extend the application scene, and perform quantitative evaluation for improving the search efficiency of the optimal solution.

The evaluation device may further include a candidate experimental point creation unit that creates the candidate experimental point by combining values that satisfy predetermined conditions of a plurality of control factors.

For example, the predetermined condition is a condition that the sum of the values of the respective ratio variables of the plurality of control factors is 1. In a more specific example, the ratio variable is a compound ratio of materials such as compounds corresponding to the control factor. Therefore, for each combination of compound ratios of a plurality of types of compounds, an evaluation value for the combination can be calculated. As a result, it is possible to appropriately search for an optimal solution for at least one objective characteristic of the synthetic material obtained by compounding these compounds.

The calculator may calculate the evaluation value based on a constraint range having a shape different from a rectangle of the at least one constraint range.

Due to this, in a characteristic space expressed by two objective characteristics, for example, an evaluation value is calculated based on a constraint range such as a circle, an ellipse, or a star. Therefore, not limited to a case where the shape of the constraint range is rectangular, the application scene can be further extended.

In a case where the at least one constraint range comprises a plurality of constraint ranges, the calculator may further divide the case (ii) into a plurality of cases, and calculate the evaluation value by performing weighting processing different from one another among the plurality of cases, and in each of the plurality of cases, the interval may be included in constraint ranges different from one another among the plurality of constraint ranges.

For example, the plurality of constraint ranges are a standard range and a management range included in the standard range. Then, the case of (ii) is divided into a first case where the interval is within the standard range and out of the management range and the optimization objective is the first objective, and a second case where the interval is within the management range and the optimization objective is the first objective. Weighting processing, for example, in which a larger weight is used in the second case than in the first case is performed. Thus, when there are a plurality of constraint ranges, and by further dividing the case (ii) into a plurality of cases, it is possible to perform weighting on each of the plurality of constraint ranges in a stepwise manner. Therefore, it is possible to appropriately calculate the evaluation value even in a case where the value of the objective characteristic falls within the standard range and is desired to fall within the management range as much as possible. As a result, it is possible to further extend the application scene for the optimization problem.

The calculator may give priority to each of the at least one objective characteristic and calculate the evaluation value using the priority having been given.

Due to this, since at least one objective characteristic is given priority, the objective characteristic given high priority can be brought close to the optimization objective earlier than the objective characteristic given low priority.

The calculator may further calculate a minimum distance of distances between the candidate experimental point and respective one or more of the experimented experimental points, and the output unit may further output the minimum distance corresponding to the candidate experimental point.

Due to this, since the minimum distance corresponding to each candidate experimental point is output, the user of the evaluation device can select the candidate experimental point that becomes the next experimental point based on not only the evaluation value but also the minimum distance. For example, at an initial stage of the optimal solution search, the evaluation value of a candidate experimental point close to the experimental point already used in the experiment tends to become large, and there is a possibility that such a candidate experimental point does not greatly contribute to optimization even if selected for next experiment. Therefore, the user can improve the accuracy of the evaluation value and perform appropriate optimization, for example, by selecting, as a next experimental point, a candidate experimental point having a relatively large evaluation value and corresponding to an evaluation value having a relatively long minimum distance.

The calculator may calculate the evaluation value using a Monte Carlo method.

Due to this, since the Monte Carlo method is an approximation method, the processing load for calculation of the evaluation value can be reduced.

The calculator may calculate the evaluation value using at least one of probability of improvement (PI) and expected improvement (EI), each of which is an evaluation method.

Due to this, for each candidate experimental point, it is possible to calculate, as an optimization improvement amount, the volume within the constraint range in a characteristic space, and appropriately calculate the evaluation value from the improvement amount.

The exemplary embodiment will specifically be described below with reference to the drawings.

Each exemplary embodiment to be described below provides a comprehensive or specific example. Numerical values, shapes, materials, constituent elements, disposition positions and connection modes of the constituent elements, steps, order of the steps, and the like illustrated in the following exemplary embodiment are merely examples, and therefore are not intended to limit the present disclosure. Those constituent elements in the following exemplary embodiment that are not recited in the independent claims representing the most superordinate concept are illustrated herein as optional constituent elements. Each of the drawings is a schematic view, and is not necessarily precisely illustrated. In the respective drawings, identical components are denoted by identical reference symbols.

### EXEMPLARY EMBODIMENT

### [Outline]

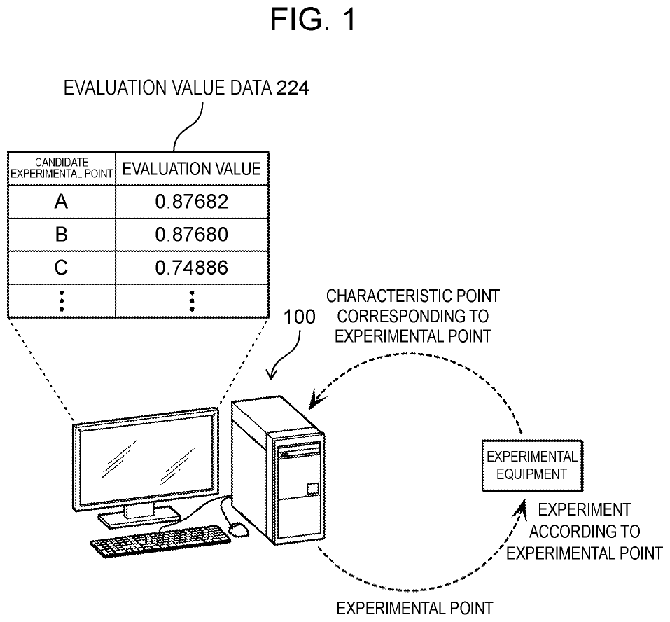

FIG. 1 is a view for explaining a schematic operation of an evaluation device in the present exemplary embodiment.

Evaluation device 100 on the present exemplary embodiment calculates an evaluation value for each of a plurality of candidate experimental points, and displays evaluation value data 224 indicating those evaluation values. The candidate experimental point is a point that is a candidate for the experimental point. The experimental point indicates an experimental condition (combination of values of control factors in an experimental space). The evaluation value is a value indicating an evaluation result of an objective characteristic predicted to be obtained by an experiment according to the candidate experimental point. For example, the evaluation value indicates a degree to which the objective characteristic predicted to be obtained by the experiment matches an optimization objective, and the larger the evaluation value is, the larger the degree is.

With reference to the evaluation value of each candidate experimental point indicated by evaluation value data 224, the user selects one of those candidate experimental points as a next experimental point. Using experimental equipment, the user conducts an experiment according to the selected experimental point. Through an experiment, a characteristic point corresponding to the experimental point is obtained. The characteristic point indicates, for example, the value of an objective characteristic, and where there are a plurality of objective characteristics, the characteristic point is indicated as a combination of the values of the plurality of objective characteristics. The user inputs the obtained characteristic point into evaluation device 100 in association with an experimental point. As a result, evaluation device 100 calculates again an evaluation value for each unselected candidate experimental point using the characteristic points obtained by the experiment, and displays again evaluation value data 224 indicating those evaluation values. That is, evaluation value data 224 is updated. By repeating such update of evaluation value data 224, evaluation device 100 searches for an optimal solution of the objective characteristic.

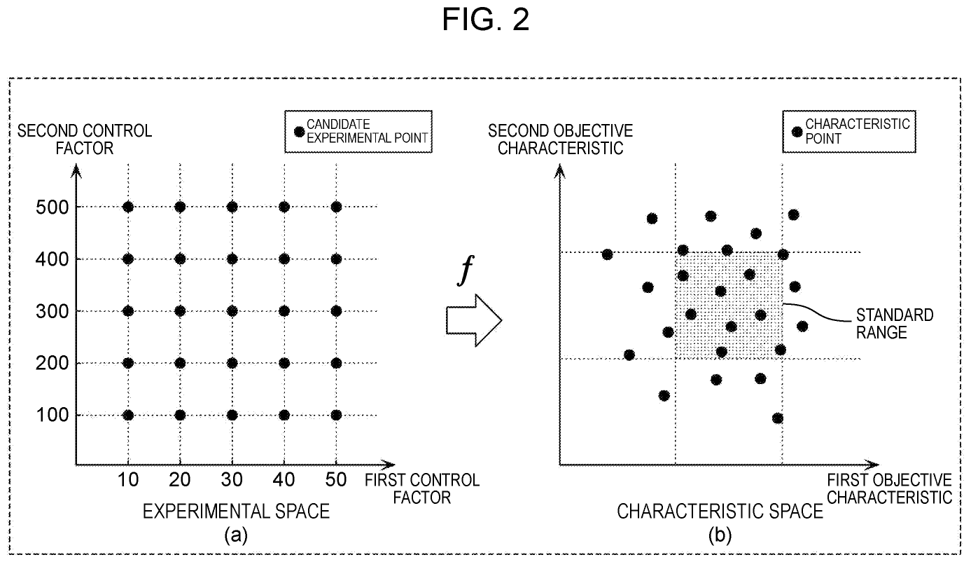

FIG. 2 is a view illustrating an example in which each candidate experimental point and each characteristic point are represented by a graph. Specifically, the graph in part (a) of FIG. 2 illustrates candidate experimental points arranged in the experimental space, and the graph in part (b) of FIG. 2 illustrates characteristic points arranged in the characteristic space.

The candidate experimental points in the experimental space are arranged on the grid points corresponding to the combination of the values of a first control factor and a second control factor as illustrated in part (a) of FIG. 2. The characteristic points corresponding to respect candidate experimental points illustrated in part (a) of FIG. 2 are arranged in the characteristic space as illustrated in part (b) of FIG. 2. Specifically, when the candidate experimental point is selected as the experimental point, and the respective values of a first objective characteristic and a second objective characteristic are obtained through an experiment according to the experimental point, the characteristic point corresponding to the experimental point is arranged at the position expressed by a combination of the value of the first objective characteristic and the value of the second objective characteristic. Here, there is a one-to-one correspondence relationship between the candidate experimental points and the characteristic points, but the correspondence relationship (that is, function fin FIG. 2) is unknown.

Executing an experiment once can be rephrased as selecting one candidate experimental point and acquiring one set of correspondence relationship with the characteristic point corresponding to the selected candidate experimental point.

As illustrated in part (b) of FIG. 2, by the set standard range, the characteristic space is divided into a region in the standard range and a region out of the standard range. For example, the optimization objective of the objective characteristic may be maximization or minimization of the value of the objective characteristic. In the present exemplary embodiment, a constraint condition that is a standard range may be given to an objective characteristic having the optimization objective. The constraint condition is a condition given to the objective characteristic, and for example, there is a constraint range designating a range of the value of an objective characteristic as a condition. Examples of the constraint range include a standard range defined by the standard of the objective characteristic, and a management range that can be appropriately set by the user.

In the present exemplary embodiment, an example in which the number of control factors is two as in the first control factor and the second control factor and the number of objective characteristics is two as in the first objective characteristic and the second objective characteristic will be mainly explained. However, the number of control factors and the number of objective characteristics are not limited to two. The number of control factors may be one or three or more, and the number of objective characteristics may be one or three or more. The number of control factors and the number of objective characteristics may be equal to or different from each other.

[Hardware Configuration]

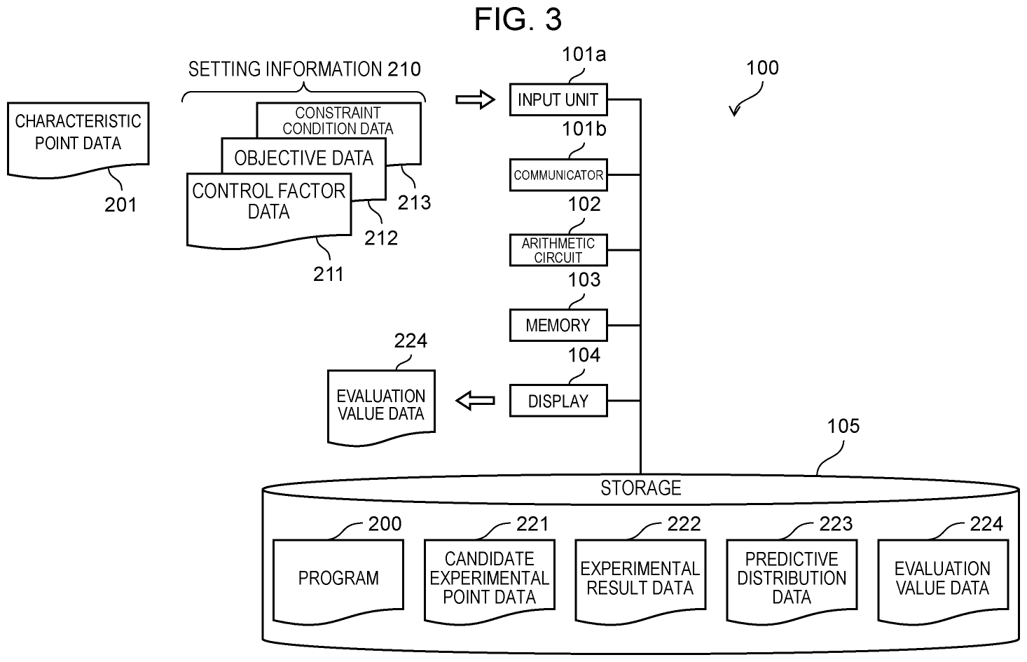

FIG. 3 is a view illustrating a configuration of evaluation device 100 in the present exemplary embodiment.

Evaluation device 100 includes input unit 101a, communicator 101b, arithmetic circuit 102, memory 103, display 104, and storage 105.

Input unit 101a is a human machine interface (HMI) that accepts an input operation by the user. Input unit 101a is, for example, a keyboard, a mouse, a touch sensor, a touchpad, or the like.

For example, input unit 101a accepts setting information 210 as an input from the user. Setting information 210 includes control factor data 211, objective data 212, and constraint condition data 213. Control factor data 211 is, for example, data indicating possible values of the control factor as illustrated in part (a) of FIG. 2. The value of the control factor may be a continuous value or a discrete value. Objective data 212 is, for example, data indicating an optimization objective of an objective characteristic such as minimization or maximization. Constraint condition data 213 is, for example, data indicating a constraint condition such as a constraint range.

Communicator 101b is connected to another apparatus in a wired or wireless manner, and transmits and receives data to and from the other apparatus. For example, communicator 101b receives characteristic point data 201 from another device (for example, an experimental device).

Display 104 displays an image, a character, or the like. Display 104 is, for example, a liquid crystal display, a plasma display, an organic electro-luminescence (EL) display, or the like. Display 104 may be a touchscreen integrated with input unit 101a.

Storage 105 stores program (that is, computer program) 200 in which commands to arithmetic circuit 102 are described and various data. Storage 105 is a nonvolatile recording medium, and is, for example, a magnetic storage device such as a hard disk, a semiconductor memory such as a solid state drive (SSD), an optical disk, or the like. Program 200 and various data may be provided, for example, from the above-described other apparatus to evaluation device 100 via communicator 101b and stored in storage 105. Storage 105 stores, as various data, candidate experimental point data 221, experimental result data 222, predictive distribution data 223, and evaluation value data 224.

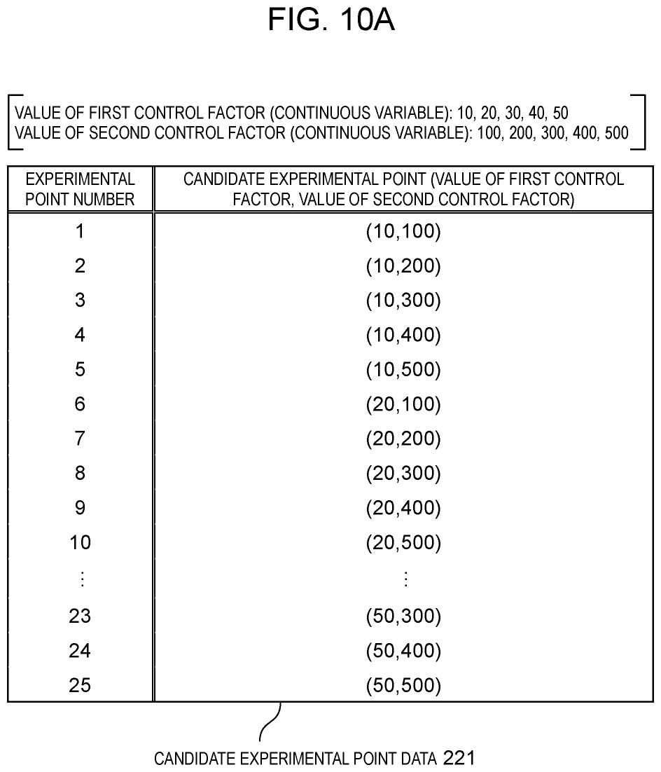

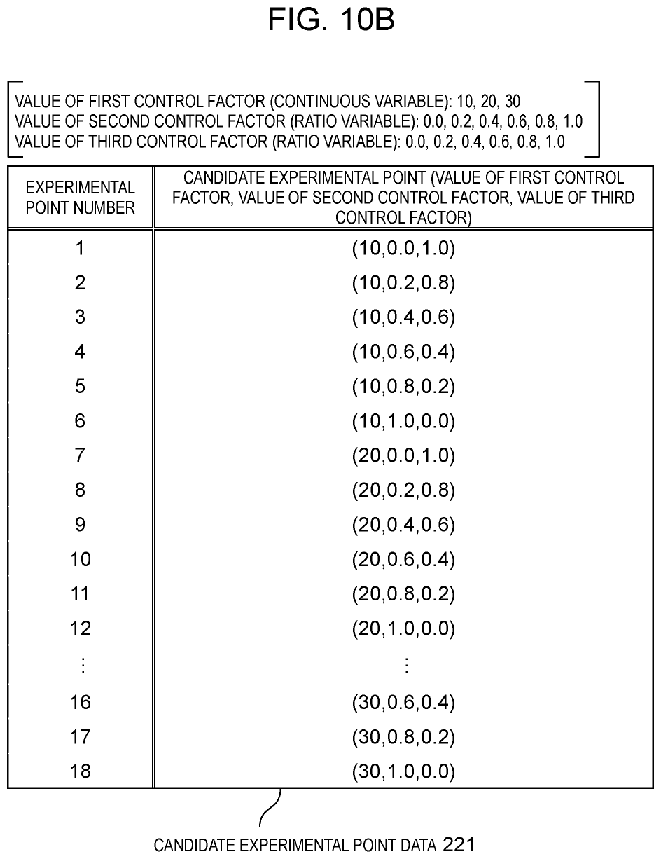

Candidate experimental point data 221 is data indicating each candidate experimental point. In the example of part (a) of FIG. 2, each candidate experimental point is expressed by a combination of values of the first control factor and the second control factor. Candidate experimental point data 221 may be data in a table format in which combinations of values of the first control factor and the second control factor are listed. A specific example of such candidate experimental point data 221 will be described in detail with reference to FIGS. 10A and 10B.

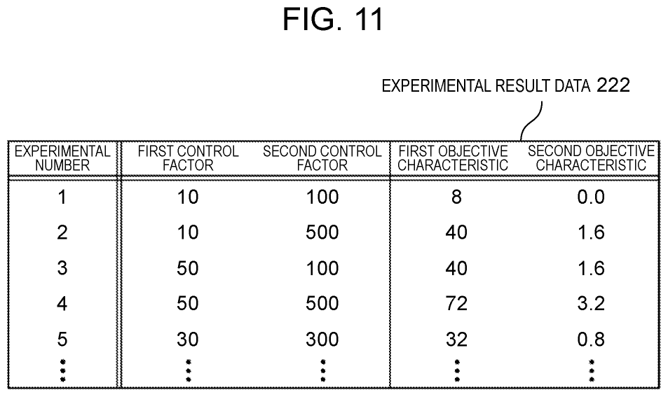

Experimental result data 222 is data indicating one or more experimental points used in an experiment and characteristic points respectively corresponding to the one or more experimental points. For example, experimental result data 222 indicates a combination of an experimental point on the experimental space in part (a) of FIG. 2 and a characteristic point on the characteristic space in part (b) of FIG. 2 obtained by an experiment using the experimental point. The experimental point is expressed by a combination of values of the first control factor and the second control factor, and the characteristic point is expressed by a combination of values of the first objective characteristic and the second objective characteristic. Experimental result data 222 may be data in a table format in which combinations of the experimental points and the characteristic points are listed. A specific example of experimental result data 222 will be described in detail with reference to FIG. 11.

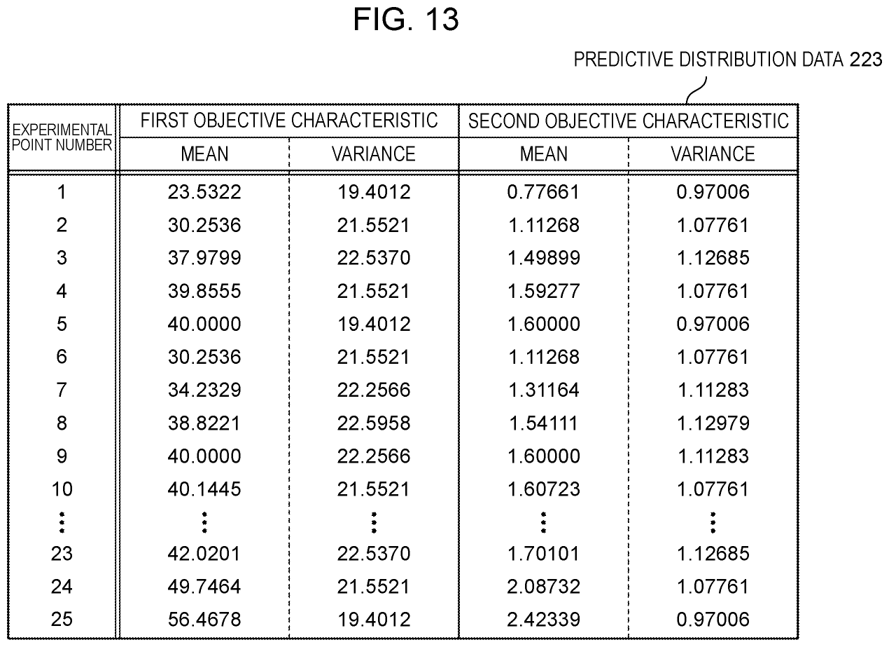

Predictive distribution data 223 is data indicating a predictive distribution of candidate experimental points not selected as the experimental point among the candidate experimental points indicated by candidate experimental point data 221. The predictive distribution is a distribution obtained by Gaussian process regression as described above, and is expressed by a mean and a variance, for example. For example, predictive distribution data 223 may be data in a table format indicating the predictive distribution of the first objective characteristic and the predictive distribution of the second objective characteristic in association with each candidate experimental point. A specific example of predictive distribution data 223 will be described in detail with reference to FIG. 13.

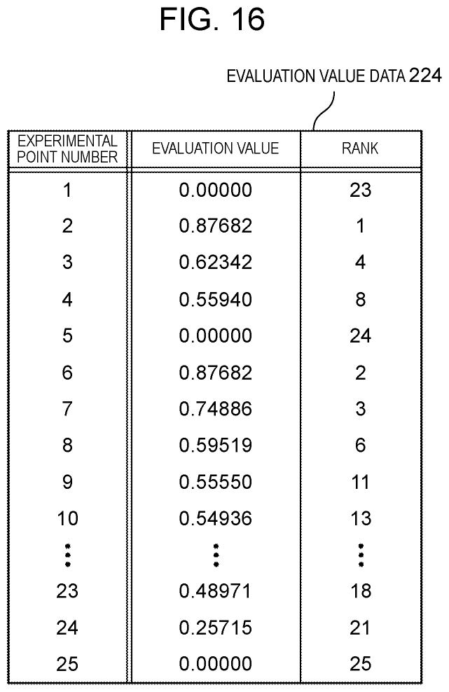

Evaluation value data 224 is data indicating an evaluation value for each of the plurality of candidate experimental points as illustrated in FIG. 1, for example. For example, evaluation value data 224 may be data in a table format indicating the evaluation value in association with each of the plurality of candidate experimental points. Another specific example of evaluation value data 224 will be described in detail with reference to FIG. 16.

Arithmetic circuit 102 is a circuit that reads program 200 from storage 105 to memory 103 and executes program 200 having been expanded. Arithmetic circuit 102 is, for example, a central processing unit (CPU), a graphics processing unit (GPU), or the like.

[Functional Configuration]

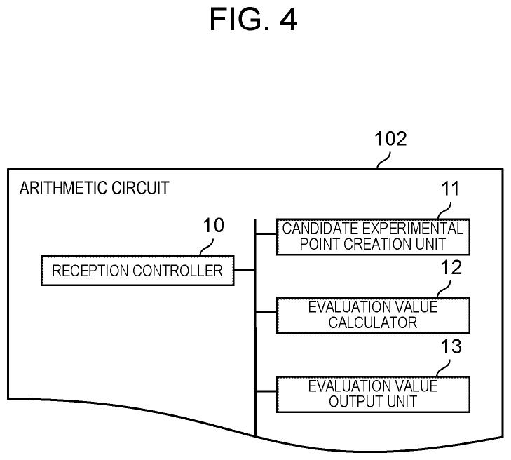

FIG. 4 is a block diagram illustrating a functional configuration of arithmetic circuit 102.

Arithmetic circuit 102 implements a plurality of functions for generating evaluation value data 224 by executing program 200. Specifically, arithmetic circuit 102 includes reception controller (first receiver, second receiver, and third receiver) 10, candidate experimental point creation unit 11, evaluation value calculator (calculator) 12, and evaluation value output unit (output unit) 13.

Reception controller 10 receives characteristic point data 201, control factor data 211, objective data 212, and constraint condition data 213 via input unit 101a or communicator 101b. For example, when characteristic point data 201 is input by an input operation to input unit 101a by the user, reception controller 10 writes the characteristic point indicated in characteristic point data 201 into experimental result data 222 of storage 105 in association with the experimental point. Due to this, experimental result data 222 is updated. When experimental result data 222 is updated, reception controller 10 causes evaluation value calculator 12 to execute processing using experimental result data 222 having been updated. That is, reception controller 10 causes evaluation value calculator 12 to execute calculation of the evaluation value. At this time, evaluation value calculator 12 executes calculation of the evaluation value using candidate experimental point data 221 already stored in storage 105. In this manner, reception controller 10 causes evaluation value calculator 12 to start calculation of the evaluation value with the input of characteristic point data 201 as a trigger.

Reception controller 10 may cause evaluation value calculator 12 to start calculation of the evaluation value in response to another trigger. For example, when experimental result data 222 has already been stored in storage 105, reception controller 10 may cause evaluation value calculator 12 to start calculation of the evaluation value with the input of the level of the experimental point by the user as a trigger. The level of the experimental point is, for example, a minimum value, a maximum value, and a discrete width of possible values of the control factor. That is, when the level of the experimental point is input by the user and candidate experimental point data 221 is generated based on the level, reception controller 10 causes evaluation value calculator 12 to start calculation of the evaluation value based on candidate experimental point data 221 and experimental result data 222.

Alternatively, when candidate experimental point data 221 has already been stored in storage 105, reception controller 10 may cause evaluation value calculator 12 to start calculation of the evaluation value with the input of experimental result data 222 by the user as a trigger. When experimental result data 222 is input by the user, reception controller 10 causes evaluation value calculator 12 to start calculation of the evaluation value based on experimental result data 222 and candidate experimental point data 221.

Alternatively, when candidate experimental point data 221 has already been stored in storage 105, reception controller 10 may cause evaluation value calculator 12 to start calculation of the evaluation value with the reception of experimental result data 222 by communicator 101b as a trigger. For example, experimental equipment, an experimental device, a manufacturing device, or the like transmits experimental result data 222 to evaluation device 100, and communicator 101b receives experimental result data 222. When experimental result data 222 is received by communicator 101b, reception controller 10 causes evaluation value calculator 12 to start calculation of the evaluation value based on experimental result data 222 and candidate experimental point data 221.

Thus, when there are candidate experimental point data 221 and experimental result data 222, reception controller 10 causes evaluation value calculator 12 to start calculation of the evaluation value based on them. When experimental result data 222 has already been stored in storage 105, reception controller 10 may cause evaluation value calculator 12 to start calculation of the evaluation value with the input of candidate experimental point data 221 by the user as a trigger. When candidate experimental point data 221 and experimental result data 222 have already been stored in storage 105, reception controller 10 may cause evaluation value calculator 12 to start calculation of the evaluation value with the input of a start instruction by the user as a trigger.

Candidate experimental point creation unit 11 generates candidate experimental point data 221 based on control factor data 211 acquired by reception controller 10. That is, candidate experimental point creation unit 11 creates each of the plurality of candidate experimental points using the value of respective one or more control factors. Then, candidate experimental point creation unit 11 stores, in storage 105, candidate experimental point data 221 having been generated.

Evaluation value calculator 12 reads candidate experimental point data 221 and experimental result data 222 from storage 105, generates predictive distribution data 223 based on these data, and stores predictive distribution data 223 into storage 105. Furthermore, evaluation value calculator 12 generates evaluation value data 224 based on predictive distribution data 223, and objective data 212 and constraint condition data 213 acquired by reception controller 10, and stores evaluation value data 224 into storage 105.

Evaluation value output unit 13 reads evaluation value data 224 from storage 105 and outputs evaluation value data 224 to display 104. Alternatively, evaluation value output unit 13 may output evaluation value data 224 to an external device via communicator 101b. That is, evaluation value output unit 13 outputs the evaluation value of each candidate experimental point. Evaluation value output unit 13 may directly acquire evaluation value data 224 from evaluation value calculator 12 and output evaluation value data 224 to display 104. Similarly, evaluation value output unit 13 reads predictive distribution data 223 from storage 105 and outputs predictive distribution data 223 to display 104. Evaluation value output unit 13 may directly acquire predictive distribution data 223 from evaluation value calculator 12 and output predictive distribution data 223 to display 104.

[Input]

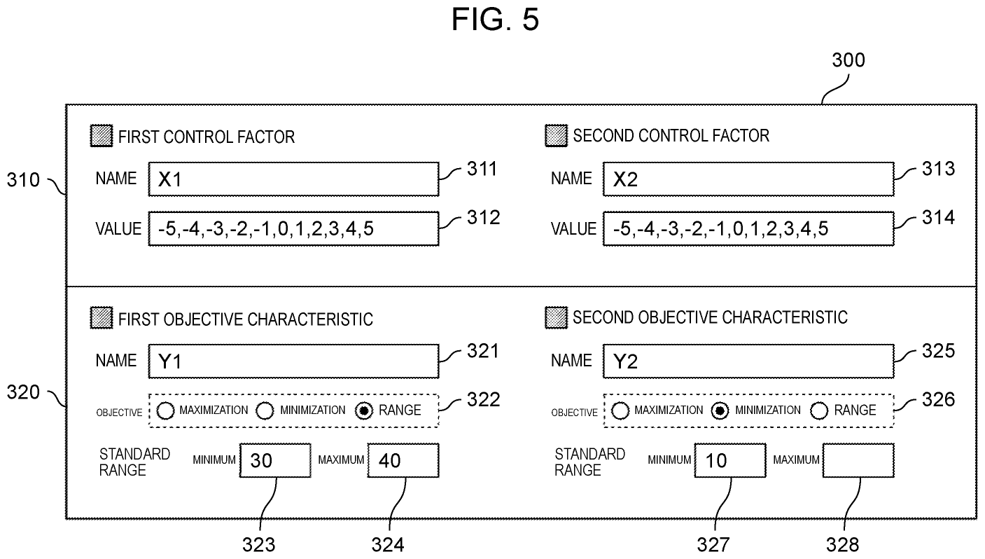

FIG. 5 is a view illustrating an example of an acceptance image displayed on display 104 for accepting input of setting information 210.

Acceptance image 300 includes control factor region 310 and objective characteristic region 320. Control factor region 310 is a region for accepting input of control factor data 211. Objective characteristic region 320 is a region for accepting input of objective data 212 and constraint condition data 213.

Control factor region 310 has input fields 311 to 314. Input field 311 is a field for inputting the name of the first control factor. For example, in input field 311, “Xl” is input as the name of the first control factor. Input field 312 is a field for inputting the value of the first control factor. For example, in input field 312, “−5, −4, −3, −2, −1, 0, 1, 2, 3, 4, 5” is input as the value of the first control factor. Similarly, input field 313 is a field for inputting the name of the second control factor. For example, in input field 313, “X2” is input as the name of the second control factor. Input field 314 is a field for inputting the value of the second control factor. For example, in input field 314, “−5, −4, −3, −2, −1, 0, 1, 2, 3, 4, 5” is input as the value of the second control factor.

By such input to input fields 311 to 314, control factor data 211 corresponding to the input result is input to evaluation device 100.

Objective characteristic region 320 has input fields 321 to 328. Input fields 321 and 325 are fields for inputting the names of the first objective characteristic and the name of the second objective characteristic. For example, “Y1” is input as the name of the first objective characteristic into input field 321, and “Y2” is input as the name of the second objective characteristic into input field 325. Input fields 322 and 326 are fields for selecting optimization objectives of the first objective characteristic and the second objective characteristic. Specifically, each of input fields 322 and 326 has three radio buttons for selecting any one of “maximization”, “minimization”, and “within the standard range” as an objective. The objective of “maximization” as an objective is maximization of the value of the first objective characteristic or the second objective characteristic, and the objective “minimization” is minimization of the value of the first objective characteristic or the second objective characteristic. The object of “within the standard range” is that the value of the first objective characteristic or the second objective characteristic falls within the standard range. For example, in a case where the radio button indicating “within the standard range” is selected by the input operation to input unit 101a by the user, evaluation device 100 selects “within the standard range” as the optimization objective of the first objective characteristic or the second objective characteristic. Input fields 323 and 324 are fields for inputting the minimum value and the maximum value, respectively, indicating the standard range of the first objective characteristic. For example, in a case where “30” is input as the minimum value into input field 323 and “40” is input as the maximum value into input field 324, evaluation device 100 sets the standard range to 30 to 40. Input fields 327 and 328 are fields for inputting the minimum value and the maximum value, respectively, in the standard range of the second objective characteristic. For example, in a case where “10” is input as the minimum value of the standard range into input field 327 and nothing has yet input into input field 328, evaluation device 100 sets the standard range to 10 to +∞. In a case where nothing has yet input into input field 327, evaluation device 100 sets the minimum value of the standard range to −∞.

By such input to input fields 321 to 328, objective data 212 and constraint condition data 213 corresponding to the input result are input to evaluation device 100. That is, reception controller 10 acquires objective data 212 according to the input into input fields 322 and 326, and acquires constraint condition data 213 according to the input into input fields 323, 324, 327, and 328. In the example of FIG. 5, objective data 212 indicates that the value of the first objective characteristic falls within the standard range as the optimization objective of the first objective characteristic, and indicates the minimization of the value of the second objective characteristic as the optimization objective of the second objective characteristic. Constraint condition data 213 indicates that the standard range of the first objective characteristic is 30 to 40 and the standard range of the second objective characteristic is 10 to +∞.

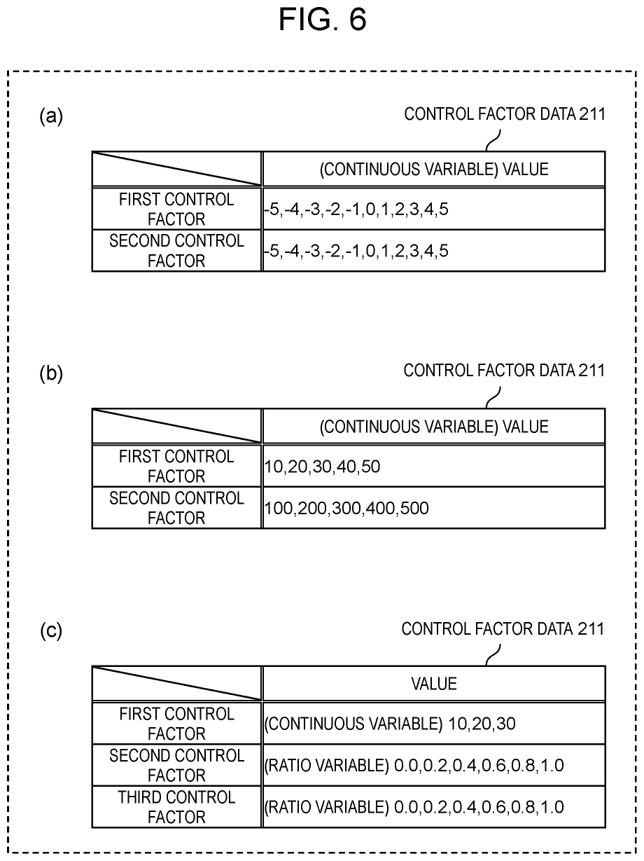

FIG. 6 is a view illustrating an example of control factor data 211.

For example, in the example of control factor data 211 illustrated in part (a) of FIG. 6, the first control factor and the second control factor can take values discrete by 1 from −5 to 5. In the example illustrated in part (a) of FIG. 6, the first control factor and the second control factor are continuous variables. The continuous variable can take a continuous value, but it is difficult to perform arithmetic processing with the continuous value. Therefore, it is preferable to discretize the value of each control factor and set a finite number of candidate experimental points. Therefore, when the control factor is a continuous variable, the user inputs a level (minimum value, maximum value, and discrete width) of the control factor, and evaluation device 100 decides a possible value of the control factor. That is, reception controller 10 receives the level of the control factor according to the input operation to input unit 101a by the user, and decides the possible value of the control factor based on the level. Then, reception controller 10 generates control factor data 211 indicating the decided possible value of the control factor, and displays it in input field 312 or 314 included in control factor region 310 of acceptance image 300 in FIG. 5, for example.

The variable includes a discrete variable different from a continuous variable. When the control factor is a discrete variable, the discrete variable does not have a magnitude relationship and a numerical magnitude such as “apple, orange, and banana” or “with catalyst, and without catalyst”.

In the example in part (a) of FIG. 6, the first control factor and the second control factor can take the same value, but the present disclosure is not limited to this. For example, as illustrated in part (b) of FIG. 6, possible values of the first control factor and the second control factor may be different from each other. In the example of control factor data 211 illustrated in part (b) of FIG. 6, the first control factor can take a value discrete by 10 from 10 to 50. On the other hand, the second control factor can take a value discrete by 100 from 100 to 500.

In the examples illustrated in parts (a) and (b) of FIG. 6, the value of the control factor is an absolute value, but the present disclosure is not limited to this. The value of the control factor may be a relative value such as a ratio to the sum of the value of another control factor or the values of all control factors. In the example illustrated in part (c) of FIG. 6, control factor data 211 indicates the value of a ratio variable different from the value of a continuous variable. The ratio variable can take a relative value such as the ratio described above. For example, as illustrated in part (c) of FIG. 6, control factor data 211 may indicate the value of the continuous variable of the first control factor, the value of the ratio variable of the second control factor, and the value of the ratio variable of the third control factor. Specifically, the value of the continuous variable of the first control factor can be a value discrete by 10 from 10 to 30, for example. The value of the ratio variable of the second control factor is, for example, “0.0, 0.2, 0.4, 0.6, 0.8, 1.0”, and the value of the ratio variable of the third control factor is, for example, “0.0, 0.2, 0.4, 0.6, 0.8, 1.0”. The ratio variable indicates a compound ratio of the material of the first control factor or the second control factor in a synthetic material generated by compounding the material of the first control factor and the material of the second control factor, for example.

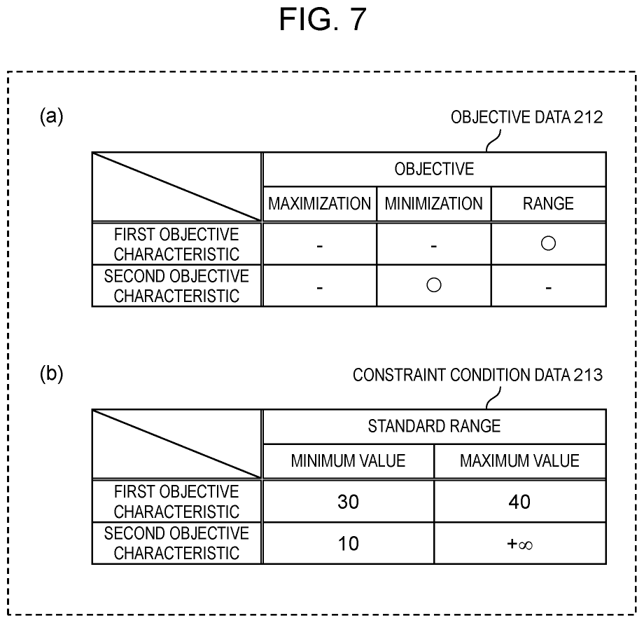

Part (a) of FIG. 7 is a view illustrating an example of objective data 212, and part (b) of FIG. 7 is a view illustrating an example of constraint condition data 213.

Objective data 212 input by objective characteristic region 320 of acceptance image 300 of FIG. 5 indicates the optimization objective of the first objective characteristic and the optimization objective of the second objective characteristic as illustrated in part (a) of FIG. 7, for example. Constraint condition data 213 input by objective characteristic region 320 of acceptance image 300 in FIG. 5 indicates the standard range of the first objective characteristic and the standard range of the second objective characteristic as illustrated in part (b) of FIG. 7, for example. Specifically, objective data 212 indicates “within the standard range” as the optimization objective of the first objective characteristic, and indicates “minimization” as the optimization objective of the second objective characteristic. Constraint condition data 213 indicates a range from the minimum value “30” to the maximum value “40” as the standard range of the first objective characteristic, and indicates a range from the minimum value “10” to the maximum value “+∞” as the standard range of the second objective characteristic. Therefore, the optimization objective of the second objective characteristic is minimization of the value of the second objective characteristic within the standard range greater than or equal to the minimum value “10”.

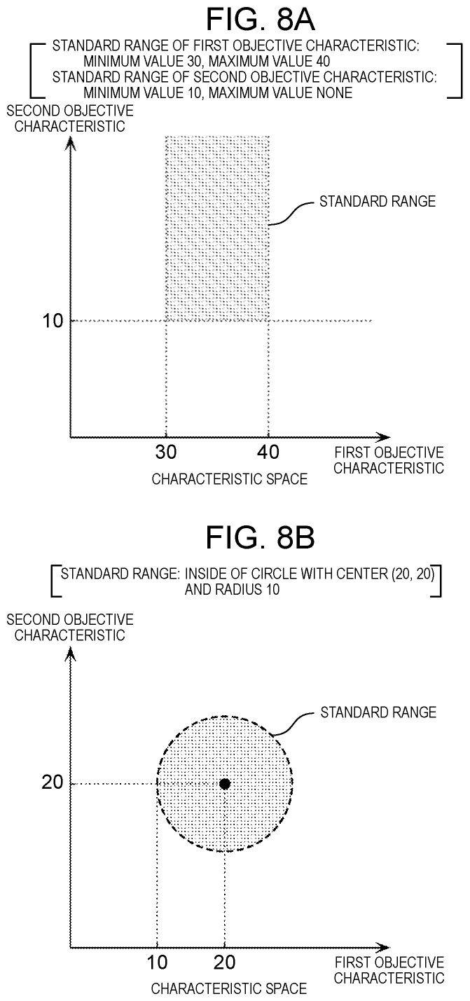

FIG. 8A is a view illustrating an example of the standard range.

The standard range indicated by constraint condition data 213 in part (b) of FIG. 7 is expressed by a rectangular range on the characteristic space as in FIG. 8A, for example. In the example illustrated in FIG. 8A, the shape of the standard range is rectangular, but it may be another shape. That is, the shape of the standard range may be any shape as long as calculation of the evaluation value described later is implementable.

FIG. 8B is a view illustrating another example of the standard range.

The standard range may have, for example, a circular shape as illustrated in FIG. 8B. In a specific example, the standard range in the characteristic space of the first objective characteristic and the second objective characteristic is expressed by the center (20, 20) and the radius 10 of a circle. The shape of the standard range may be a shape other than the circle, and may be an ellipse, a star, or the like.

Thus, in the present exemplary embodiment, evaluation value calculator 12 may calculate the evaluation value of each candidate experimental point based on the standard range having the shape different from a rectangle. Due to this, in a characteristic space, an evaluation value is calculated based on a standard range such as a circle, an ellipse, or a star. Therefore, not limited to a case where the shape of the standard range is rectangular, the application scene can be further extended.

[Processing Operation]

Evaluation device 100 performs processing related to calculation and output of the evaluation value using each data having been input as described above.

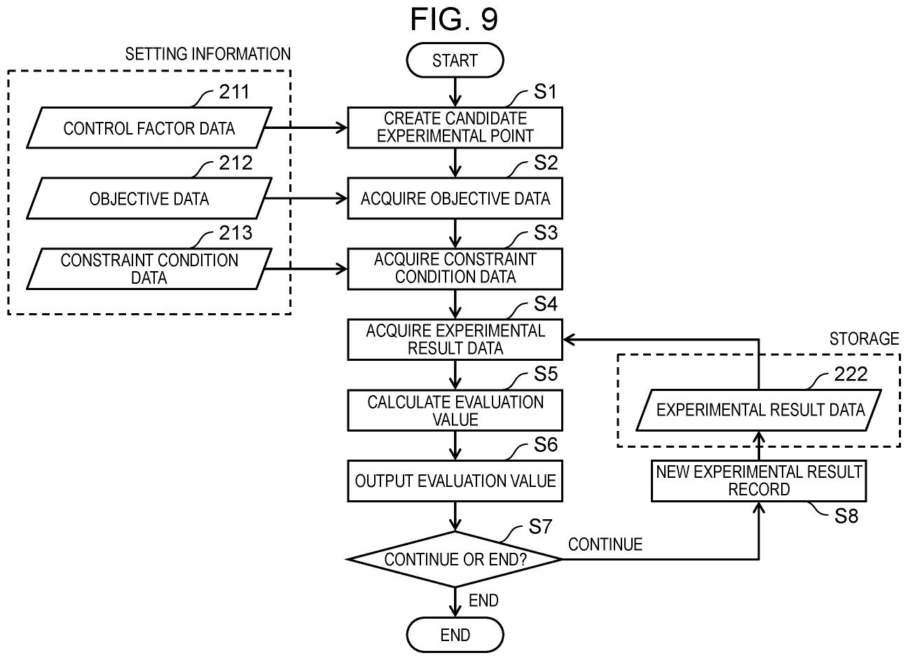

FIG. 9 is a flowchart illustrating a processing operation of evaluation device 100 in the present exemplary embodiment.

First, candidate experimental point creation unit 11 generates candidate experimental point data 221 using control factor data 211 (step S1).

Next, reception controller 10 acquires objective data 212 (step S2). That is, reception controller 10 executes the second receiving of acquiring the objective data indicating the optimization objective. Reception controller 10 acquires constraint condition data 213 (step S3). That is, reception controller 10 executes the third receiving of acquiring constraint condition data 213 indicating the constraint condition given to at least one objective characteristic. Reception controller 10 reads experimental result data 222 from storage 105 (step S4). That is, reception controller 10 executes the first receiving of acquiring experimental result data 222 indicating an experimented experimental point and a known characteristic point. In a case where none of the characteristic points is indicated in experimental result data 222, the processing of steps S4 to S6 including step S4 is skipped.

Then, evaluation value calculator 12 calculates the evaluation value of each candidate experimental point based on objective data 212, constraint condition data 213, candidate experimental point data 221, and experimental result data 222 (step S5). That is, evaluation value calculator 12 executes calculating of the evaluation value of an unknown characteristic point based on those data. Specifically, evaluation value calculator 12 calculates the evaluation value of each candidate experimental point not yet used in experiment among the plurality of candidate experimental points indicated in candidate experimental point data 221. In this calculating, evaluation value calculator 12 gives weighting according to the degree of compatibility of the constraint condition to the evaluation value for at least one objective characteristic as in (Formula 4) and (Formula 5) described later. Then, evaluation value calculator 12 generates evaluation value data 224 indicating the calculated evaluation value of each candidate experimental point.

Next, evaluation value output unit 13 outputs, to display 104, the evaluation value calculated in step S5, that is, evaluation value data 224 (step S6). That is, evaluation value output unit 13 executes outputting the evaluation value. Due to this, evaluation value data 224 is displayed on display 104, for example.

Then, reception controller 10 acquires an operation signal from input unit 101a in response to an input operation to input unit 101a by the user. The operation signal indicates end of search for an optimal solution or continuation of the search for the optimal solution. The search for the optimal solution is processing of performing calculation and output of the evaluation value of each candidate experimental point based on a new experimental result. Reception controller 10 determines whether the operation signal indicates end of search for the optimal solution or indicates continuation (step S7).

When determining that the operation signal indicates the end of the search for the optimal solution (“end” in step S7), reception controller 10 ends all the processing. On the other hand, when determining that the operation signal indicates continuation of the search for the optimal solution (“continue” in step S7), reception controller 10 writes, into experimental result data 222 of storage 105, the candidate experimental point selected as the next experimental point. For example, when the user performs an input operation on input unit 101a, reception controller 10 selects the candidate experimental point as the next experimental point from evaluation value data 224. Reception controller 10 writes the thus selected candidate experimental point into experimental result data 222. Then, when the characteristic point corresponding to the next experimental point is obtained by experiment, the user performs an input operation on input unit 101a, thereby inputting, into evaluation device 100, characteristic point data 201 indicating the characteristic point. Reception controller 10 acquires characteristic point data 201 having been input, and writes the characteristic point indicated by characteristic point data 201 into experimental result data 222 of storage 105. At this time, the characteristic point is associated with the most recently selected and written experimental point. Due to this, a new experimental result is recorded in experimental result data 222 (step S8). That is, experimental result data 222 is updated. When experimental result data 222 is updated, evaluation value calculator 12 repeatedly executes the processing from step S4.

In a process through the above flow, the optimal experimental condition (that is, candidate experimental point) to be performed next can be quantitatively analyzed from a past experimental result. As a result, the development cycle can be expected to be shortened regardless of the skill of the analyst such as a user.

FIG. 10A is a view illustrating an example of candidate experimental point data 221.

Candidate experimental point creation unit 11 generates candidate experimental point data 221 illustrated in FIG. 10A based on control factor data 211 illustrated in part (b) of FIG. 6, for example. For example, in a case where each value of all the control factors indicated by control factor data 211 is a value of a continuous variable and there is no constraint regarding the value, candidate experimental point creation unit 11 creates, as a candidate experimental point, each of all combinations of the values of the control factors. In the case of control factor data 211 illustrated in part (b) of FIG. 6, control factor data 211 indicates the value “10, 20, 30, 40, 50” of the continuous variable of the first control factor and the value “100, 200, 300, 400, 500” of the continuous variable of the second control factor. Therefore, candidate experimental point creation unit 11 creates, as a candidate experimental point, each of all combinations such as a combination of the value “10” of the first control factor and the value “100” of the second control factor and a combination of the value “10” of the first control factor and the value “200” of the second control factor. Candidate experimental point creation unit 11 associates an experimental point number with the created candidate experimental point, and generates candidate experimental point data 221 indicating the candidate experimental point with which the experimental point number is associated.

In a specific example, as illustrated in FIG. 10A, candidate experimental point data 221 indicates a candidate experimental point (10, 100) associated with the experimental point number “1”, a candidate experimental point (10, 200) associated with the experimental point number “2”, a candidate experimental point (10, 300) associated with the experimental point number “3”, and the like. The first component of these candidate experimental points indicates the value of the first control factor, and the second component indicates the value of the second control factor.

Here, only a combination of values satisfying a certain constraint among all combinations of values may be created as a candidate experimental point. For example, in material development, in a case where the first compound and the second compound are set as the first control factor and the second control factor, respectively, and the compound ratio of them is set as a value, candidate experimental point creation unit 11 adopts, as the candidate experimental point, only a combination of values whose sum satisfies 1. Candidate experimental point data 221 in FIG. 10B illustrates an example of it.

FIG. 10B is a view illustrating another example of candidate experimental point data 221.

Candidate experimental point creation unit 11 generates candidate experimental point data 221 illustrated in FIG. 10B based on control factor data 211 illustrated in part (c) of FIG. 6, for example. In this case, control factor data 211 indicates “0.0, 0.2, 0.4, 0.6, 0.8, 1.0” as the value of the ratio variable of the second control factor, and indicates “0.0, 0.2, 0.4, 0.6, 0.8, 1.0” as the value of the ratio variable of the third control factor. The combination of the values of these ratio variables corresponds to the compound ratio of the first compound and the second compound described above. Therefore, candidate experimental point creation unit 11 generates, as the candidate experimental point, a combination of the value of the first control factor, the value of the second control factor, and the value of the third control factor so that the sum of the value of the ratio variable of the second control factor and the value of the ratio variable of the third control factor satisfies 1. For example, candidate experimental point creation unit 11 creates, as the candidate experimental point, a combination of values in which the sum of the values of the ratio variables satisfies 1, such as a combination of the value “10” of the first control factor, the value “0.2” of the second control factor, and the value “0.8” of the third control factor. Candidate experimental point creation unit 11 associates an experimental point number with the created candidate experimental point, and generates candidate experimental point data 221 indicating the candidate experimental point with which the experimental point number is associated.

In a specific example, as illustrated in FIG. 10B, candidate experimental point data 221 indicates a candidate experimental point (10, 0.0, 1.0) associated with the experimental point number “1”, a candidate experimental point (10, 0.2, 0.8) associated with the experimental point number “2”, a candidate experimental point (10, 0.4, 0.6) associated with the experimental point number “3”, and the like. The first component of these candidate experimental points indicates the value of the first control factor, the second component indicates the value of the second control factor, and the third component indicates the value of the third control factor.

Thus, in the present exemplary embodiment, in a case where there are a plurality of control factors, when creating each of the plurality of candidate experimental points, candidate experimental point creation unit 11 creates the candidate experimental point by combining values that satisfy a predetermined condition of each of the plurality of control factors. For example, as illustrated in FIG. 10B, the predetermined condition is a condition that the sum of the values of the ratio variables of the plurality of control factors is 1. In a more specific example, the ratio variable is a compound ratio of materials such as compounds corresponding to the control factor. Therefore, for each combination of compound ratios of a plurality of types of compounds, an evaluation value for the combination can be calculated. As a result, it is possible to appropriately search for an optimal solution for one or more objective characteristics of the synthetic material obtained by compounding these compounds.

FIG. 11 is a view illustrating an example of experimental result data 222.

Evaluation value calculator 12 reads experimental result data 222 stored in storage 105 in order to calculate the evaluation value. As illustrated in FIG. 11, experimental result data 222 indicates, for each experimental number, the experimental point used in the experiment identified by the experimental number and the characteristic point that is an experimental result obtained by the experiment. The experimental point is represented by a combination of values of each control factor. For example, the experimental point is expressed by a combination of values that is a combination of the value “10” of the first control factor and the value “100” of the second control factor. The characteristic point is expressed by a combination of values of the objective characteristics obtained in the experiment. The value of the objective characteristic is hereinafter also referred to as objective characteristic value. For example, the characteristic point is expressed by a combination of the value “8” of the first objective characteristic and the value “0.0” of the second objective characteristic.

In a specific example, as illustrated in FIG. 11, experimental result data 222 indicates an experimental point (10, 100) and a characteristic point (8, 0.0) associated with the experimental number “1”, an experimental point (10, 500) and a characteristic point (40, 1.6) associated with the experimental number “2”, an experimental point (50, 100) and a characteristic point (40, 1.6) associated with the experimental number “3”, and the like.

[Calculation Processing of Evaluation Value]

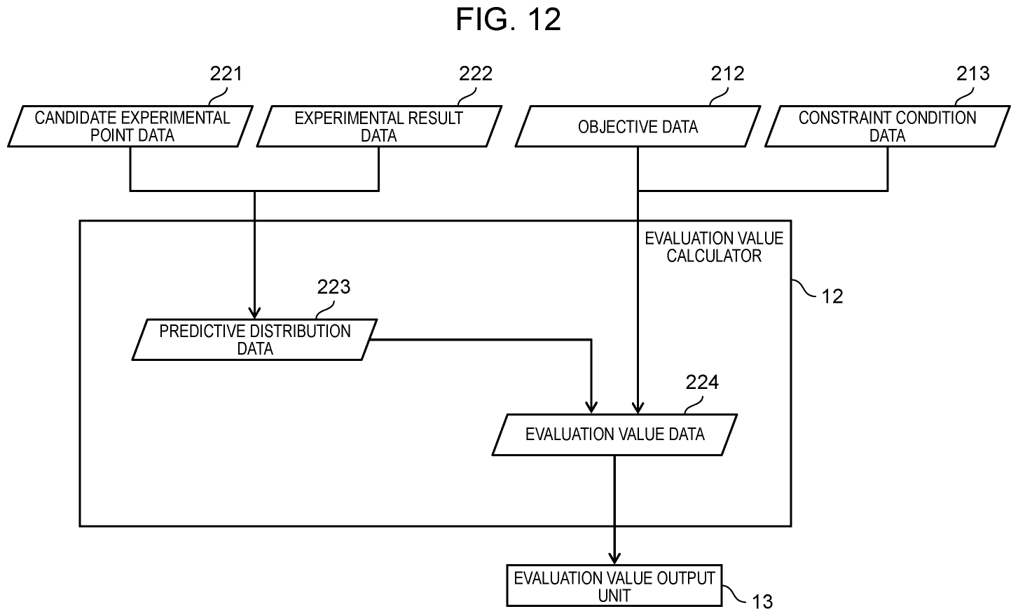

FIG. 12 is a view for explaining the processing by evaluation value calculator 12. Evaluation value calculator 12 generates predictive distribution data 223 based on candidate experimental point data 221 generated by candidate experimental point creation unit 11 and experimental result data 222 present in storage 105. Then, evaluation value calculator 12 generates evaluation value data 224 based on objective data 212 indicating the optimization objective of each objective characteristic, constraint condition data 213 indicating the standard range of each objective characteristic, and predictive distribution data 223.

Here, experimental result data 222 indicates one or more experimental points that are one or more candidate experimental points already used in the experiment among the plurality of candidate experimental points, and the characteristic points corresponding to respective one or more experimental points, the characteristic points being an experimental result of one or more objective characteristics using the experimental points. Therefore, evaluation value calculator 12 according to the present exemplary embodiment calculates, based on Bayesian optimization, the evaluation value of each of the remaining candidate experimental points excluding one or more experimental points among the plurality of candidate experimental points based on (a) the optimization objective and the standard range of each of one or more objective characteristics, (b) one or more experimental points that are one or more candidate experimental points already used for experiments among the plurality of candidate experimental points, and (c) characteristic points corresponding to respective one or more experimental points, the characteristic points indicating experimental results of one or more objective characteristics using the experimental points.

Evaluation value calculator 12 outputs, to evaluation value output unit 13, evaluation value data 224 having been generated. Evaluation value calculator 12 may also output predictive distribution data 223 to evaluation value output unit 13. Alternatively, evaluation value calculator 12 may store predictive distribution data 223 into storage 105, and evaluation value output unit 13 may read predictive distribution data 223 from storage 105 in response to an input operation to input unit 101a by the user.

Evaluation value calculator 12 describes the correspondence relationship between the candidate experimental point and the characteristic point in Gaussian process. Gaussian process is a probability process that assumes vector f(x^{N}) of a characteristic point corresponding to vector x^{N} of a finite number of candidate experimental points follows an N-dimensional normal distribution. The distance between experimental point x and experimental point x′ is determined by positive definite kernel k (x, x′), and a covariance matrix is represented using this kernel. N is an integer of 1 or more, and is the number of executed experimental results.

Normality of the multidimensional normal distribution is preserved even if the multidimensional normal distribution is conditioned with some elements. Using this nature, a simultaneous distribution of an executed experimental result in a known correspondence relationship with a candidate experimental point and a next experimental result in an unknown correspondence relationship with the candidate experimental point is considered, and a distribution conditioned with the known correspondence relationship is defined as a predictive distribution. The mean of the predictive distribution is calculated by following (Formula 1) for each dimension, and the variance of the predictive distribution is calculated by following (Formula 2) for each dimension.

[Mathematical expression 1]

\hat{m}(x_{(N+1)})=m(x_{(N+1)})+(k_{N+1})^{T}(K_{N,N}+σ²I)⁻¹(y^{N}−m(x^{N})) (Formula 1)

\hat{v}(x_{(N+1)},x_{(N+1)})=k(x_{(N+1)},x_{(N+1)})−(k_{N+1})^{T}(K_{N,N}+σ²I)⁻¹k_{N+1}+σ² (Formula 2)

In (Formula 1) and (Formula 2), x^{N}=(x₍₁₎, . . . , x_{(N)})^{T} represents a matrix where past experimental points are put together, and x_{(N+1)} represents a new candidate experimental point. y^{N}=(y₍₁₎, . . . , y_{(N)})^{T} represents a matrix where characteristic points corresponding to past experimental points are put together. k_{N+1} represents an N-dimensional vector having k(x₍ᵢ₎, x_{(N+1)}) as the i-th component, and K_{N,N} represents an N×N-gram matrix having k(x₍ᵢ₎, x₍ⱼ₎) as an (i, j) component. σ² represents an observation error, and is set to an appropriate value according to the degree of influence of an assumed observation error. I represents an N-order identity matrix. Kernel k (⋅,⋅) and its hyperparameters are appropriately set by the analyst such as a user, for example. Each of i and j is an integer from 1 to N inclusive. m is called a mean function, and is set to an appropriate function when the behavior of y_{(N+1)} with respect to x_{(N+1)} is known to some extent. When the behavior is unknown, m may be set to a constant such as 0.

Evaluation value calculator 12 generates predictive distribution data 223 by performing calculation using (Formula 1) and (Formula 2) on the known experimental result indicated in experimental result data 222 read from storage 105 in step S4.

FIG. 13 is a view illustrating an example of predictive distribution data 223. Predictive distribution data 223 indicates the mean and variance of the predictive distribution at each candidate experimental point. This predictive distribution is a distribution calculated by (Formula 1) and (Formula 2) as a conditional distribution by Gaussian process for each objective characteristic. For example, as illustrated in FIG. 13, predictive distribution data 223 indicates, for each experimental point number, the mean and variance of the predictive distribution of the first objective characteristic and the mean and variance of the predictive distribution of the second objective characteristic corresponding to the experimental point number.

In a specific example, as illustrated in FIG. 13, predictive distribution data 223 indicates a mean “23.5322” and a variance “19.4012” of the first objective characteristic and a mean “0.77661” and a variance “0.97006” of the second objective characteristic corresponding to the experimental point number “1”. Predictive distribution data 223 indicates a mean “30.2536” and a variance “21.5521” of the first objective characteristic and a mean “1.11268” and a variance “1.07761” of the second objective characteristic corresponding to the experimental point number “2”. The experimental point number is associated with the candidate experimental point as illustrated in FIG. 10A or 10B.

Evaluation value calculator 12 calculates an evaluation value based on an evaluation criterion called acquisition function in Bayesian optimization. The above-described predictive distribution is used to calculate this evaluation value. The acquisition function in the present exemplary embodiment is an acquisition function in Bayesian optimization with a constraint condition.

First, before description of the acquisition function in the present exemplary embodiment, the acquisition function of Bayesian optimization without a constraint condition (that is, EHVI of NPL 1) will be described. However, regarding maximization and minimization, minimization will be described as a representative of both of them because when one of them is inverted, it becomes equivalent to the other. In EHVI, it is considered that the larger the volume of the improvement region (also referred to as improvement amount) is, the more greatly a characteristic point that is improved from the provisional experimental results is obtained. The improvement region is a region surrounded by a Pareto boundary determined from the coordinates of a Pareto point (that is, a non-dominated solution) in at least one characteristic point already obtained from a conducted experiment and a Pareto boundary newly determined when a new characteristic point is observed. The Pareto point is a characteristic point that is provisionally a Pareto solution at the present time point. For example, when the optimization objective of each of the first objective characteristic and the second objective characteristic is minimization, there is no other characteristic point having a value of each of the first objective characteristic and the second objective characteristic smaller than the Pareto point.

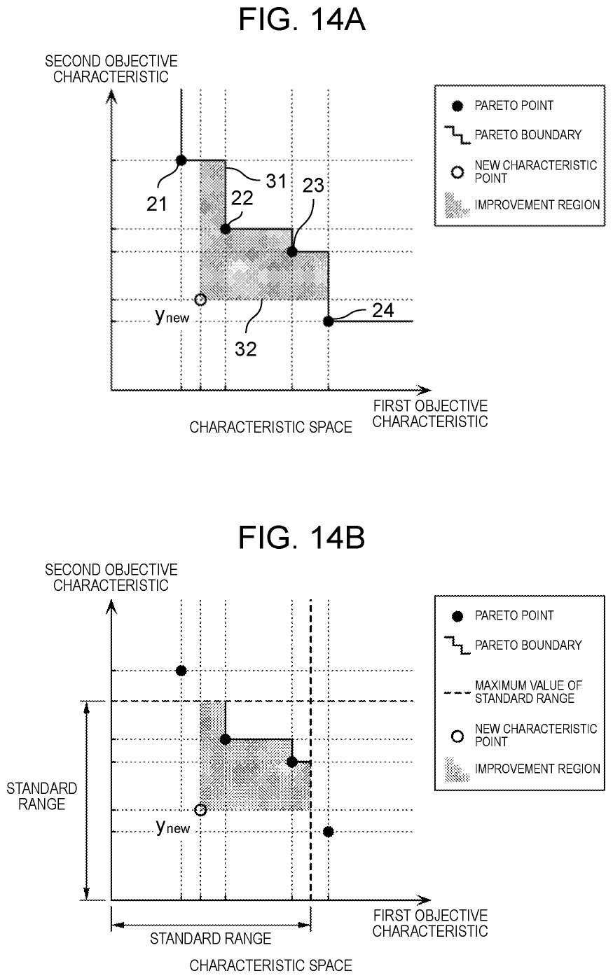

FIG. 14A is a view illustrating an example of improvement region.

For example, as illustrated in FIG. 14A, a region surrounded by Pareto boundary 31 determined from four Pareto points 21 to 24 and Pareto boundary 32 newly determined when one new characteristic point y_{new} is obtained is specified as the improvement region.

Here, the behavior of each objective characteristic value in a case where each candidate experimental point is selected by Gaussian process regression is expressed in the form of normal distribution, and the improvement amount also varies depending on the position of the observed characteristic point. EHVI is defined as an amount in which an expectation value of an improvement amount in a predictive distribution is taken for each candidate experimental point as in following (Formula 3). A candidate experimental point having a larger value obtained by EHVI has a larger expectation value of the improvement amount, and represents an experimental point to be executed next.

[Mathematical expression 2]

EHVI(x_{new})=∫_{R}_{^{D}}I(y_{new})p(y_{new}|x_{new})dy_{new} (Formula 3)

In (Formula 3), D represents the number of objective characteristics (that is, the number of dimensions), and

R^{D} [Mathematical expression 3]

represents a D-dimensional Euclidean space, and I(y_{new}) represents an improvement amount. p(y_{new}|x_{new}) represents a predictive distribution of characteristic point y_{new} corresponding to new experimental point x_{new} when one candidate experimental point is selected from at least one candidate experimental point as new experimental point x_{new}. The predictive distribution of each dimension of characteristic point y_{new}, that is, the mean and the variance are obtained by (Formula 1) and (Formula 2) described above.

Next, the acquisition function in the present exemplary embodiment will be described. The acquisition function in the present exemplary embodiment is an acquisition function of Bayesian optimization in a case where there is a constraint condition. It is assumed that among D objective characteristics, the optimization objective of D_{minimize} objective characteristics of y₁ to y_{Dminimize} is minimization, and the optimization objective of the remaining D_{range} (=D−D_{minimize}) objective characteristics of y_{Dminimize+1} to y_{D} is within the standard range. At this time, the acquisition function in the present exemplary embodiment, that is, the constrained EHVIC is defined as following (Formula 4).

[Mathematical expression 4]

EHVIC(x_{new})=∫_{Rminimize}IC(y_{new})p(y_{new,minimize}|x_{new})dy_{new,minimize}×Pr{y_{new,range}∈R_{range}} (Formula 4)

In (Formula 4), R_{minimize} represents a region where objective characteristics y₁ to y_{Dminimize} where the optimization objective is minimization are all within the standard range. R_{range} represents a region where objective characteristics y_{Dminimize+1} to y_{D} where the optimization objective is within the standard range are all within the standard range. The region of each of R_{minimize} and R_{range} is expressed by a function indicating a shape of the standard range corresponding to the region. As illustrated in FIG. 8B, when the shape of the standard range is a circle, the region of each of R_{minimize} and R_{range} is expressed by a function indicating the circle. When the shape of the standard range is a star shape, the region of each of R_{minimize} and R_{range} is expressed by a function indicating the star shape. y_{new, minimize} represents a vector obtained by extracting each dimension of the objective characteristic whose optimization objective is minimization from all dimensions of characteristic point y_{new}. y_{new, range} represents a vector obtained by extracting each dimension of the objective characteristic whose optimization objective is within the standard range from all dimensions of characteristic point y_{new}. IC(y_{new}) is an improvement amount in a case where there is a constraint condition, and represents the volume of a region surrounded by an existing Pareto boundary and a newly determined Pareto boundary. The existing Pareto boundary is a boundary determined from respective coordinates of at least one Pareto point existing within the standard range and the standard range. The newly determined Pareto boundary is a boundary determined from respective coordinates of the Pareto point that is a new characteristic point and the standard range when the new characteristic point is observed. Pr{A} represents a probability that event A is established, and is expressed using the mean and variance of (Formula 1) and (Formula 2), for example.

FIG. 14B is a view illustrating another example of the improvement region in the present exemplary embodiment. A major difference between the present exemplary embodiment and NPL 2 is that, regarding the objective characteristic where the optimization objective is minimization, in the present exemplary embodiment, an integration range is limited within a standard range from the entire characteristic space, and the way of measuring the improvement amount changes according to the standard range. When the maximum value and the minimum value in the standard range are not designated, the maximum value is set as +∞, and the minimum value is set as −∞. When the maximum value and the minimum value in the standard range of all the objective characteristics whose optimization objective is minimization are +∞ and −∞, respectively, and D_{range}=0, EHVIC, which is the acquisition function in the present exemplary embodiment, results in EHVI of NPL 1. When the maximum value and the minimum value in the standard range of all the objective characteristics whose optimization objective is minimization are +∞ and −∞, respectively, and D_{range}>=1, EHVIC, which is the acquisition function in the present exemplary embodiment, results in EHVIC of NPL 2. Therefore, evaluation device 100 in the present exemplary embodiment can calculate the evaluation value also by the conventional method.

NPL 2 assumes an optimization problem in which one or more objective characteristics whose optimization objective is minimization exist, that is, D_{minimize}>=1, but in the acquisition function in the present exemplary embodiment, formulation can be performed without any inconvenience even in a case of D_{minimize}=0 (that is, D_{range}=D). Therefore, the acquisition function in the present exemplary embodiment is naturally extended to the optimization problem in which the optimization objective of all the objective characteristics is within the standard range.

Next, a specific calculation method for EHVIC, which is the acquisition function in the present exemplary embodiment, will be described.

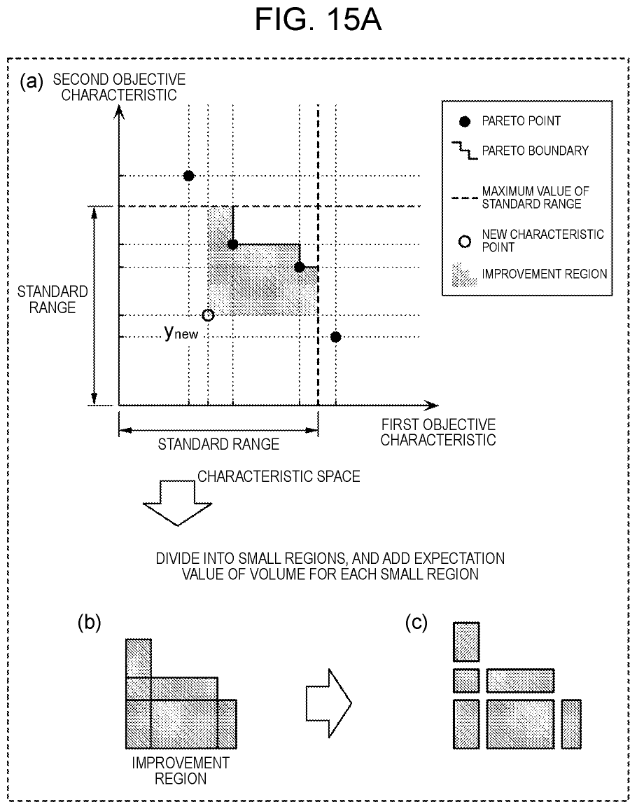

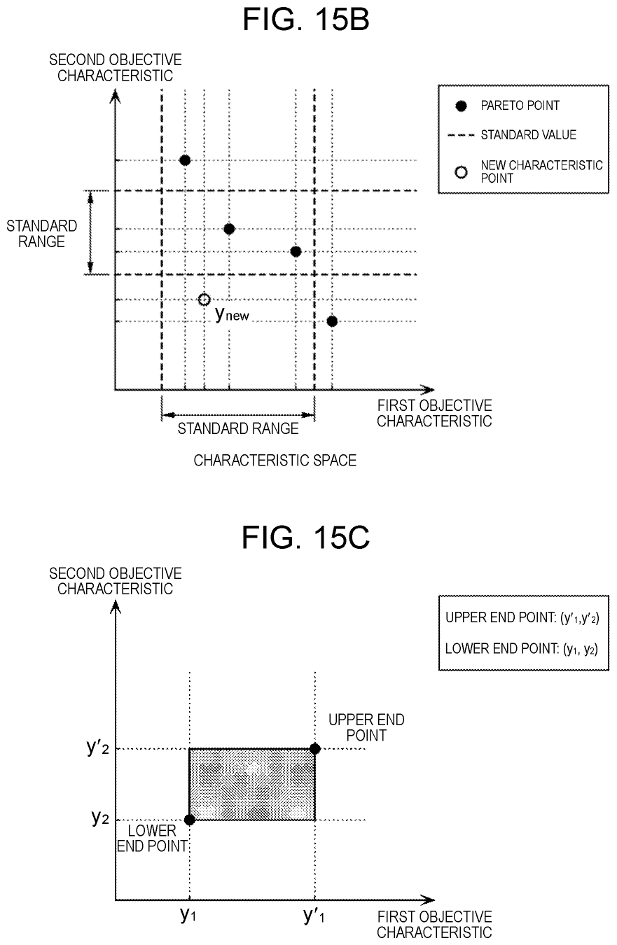

FIG. 15A is a view for explaining a calculation method for a volume of an improvement region. Part (a) of FIG. 15A illustrates an improvement region in a characteristic space, part (b) of FIG. 15A illustrates an improvement region that is a target of division, and part (c) of FIG. 15A illustrates a plurality of small regions obtained by dividing the improvement region.

Evaluation value calculator 12 calculates the improvement amount (that is, IC(y_{new})), which is the volume of the improvement region, as illustrated in FIG. 15A, for the dimension of the objective characteristic of which the optimization objective is minimization. That is, evaluation value calculator 12 divides the improvement region into a plurality of small regions at the coordinates of each of the Pareto point and the new characteristic point, calculates the expectation value of the volume of each small region, and then calculates the improvement amount (that is, IC(y_{new})) by calculating the sum of those expectation values. Evaluation value calculator 12 calculates the probability that each objective characteristic value falls within the standard range for the dimension of the objective characteristic whose optimization objective is within the standard range.

FIG. 15B is a view illustrating an example in which an entire characteristic space is divided into a plurality of small regions.

Evaluation value calculator 12 divides the entire characteristic space into a plurality of small regions as illustrated in FIG. 15B with respect to the dimension of the objective characteristic whose optimization objective is minimization and the dimension of the objective characteristic whose optimization objective is within the standard range, and uniformly calculates the acquisition function by using following (Formula 5). That is, evaluation value calculator 12 divides the entire characteristic space into a plurality of small regions at the coordinates of each of the Pareto point, the new characteristic point, and the standard value, and executes calculation of the volume of each small region by case classification calculation as in (Formula 5) below. The standard values described above are the maximum value and the minimum value of the standard range. Then, by calculating the sum of the volumes of those small regions subjected to expectation value processing, evaluation value calculator 12 uniformly calculates the acquisition function in a case where there is a constraint condition. The volume is also referred to as N-dimensional hypervolume.

$$[ Mathematical expression 5 ]$$

$$( Volume of small region ) = {{\prod }^{D}}_{d = 1} {c}_{d} \times l ( {y}_{d} , {y}_{d}^{′} ) \\ l ( {y}_{d} , {y}_{d}^{′} ) = \{ \begin{matrix}0 & ( i ) \\ 1 & ( ii ) \\ ( {y}_{d} - {y}_{d}^{′} ) & ( iii )\end{matrix} \qquad ( Formula 5 )$$

In (Formula 5), y_{d} represents the d-th component of the lower end point (y₁, . . . , y_{D}) of the small region, and y_{d}′ represents the d-th component of the upper end point (y₁′, . . . , y_{D}′) of the small region.

FIG. 15C is a view illustrating an example of a lower end point and an upper end point of the small region.

In the case of D=2, as illustrated in FIG. 15C, (y₁, y₂) represents the lower end point of the small region, and (y₁′, y₂′) represents the upper end point of the small region.

(i) in (Formula 5) is applied when the interval [y_{d}, y_{d}′] is out of the standard range regarding dimension d. (ii) is applied when the interval [y_{d}, y_{d}′] is within the standard range regarding dimension d and the optimization objective of the objective characteristic of dimension d is within the standard range. (iii) is applied when the interval [y_{d}, y_{d}′] is within the standard range regarding dimension d and the optimization objective of the objective characteristic of dimension d is minimization. c_{d} is a weighting coefficient, and is appropriately set when a search priority is given for each dimension d of the objective characteristic. For example, the higher the priority of dimension d is, the smaller weighting coefficient c_{d} is used, and conversely, the lower the priority of dimension d is, the larger weighting coefficient c_{d} is used. The reciprocal of weighting coefficient c_{d} may be priority. Unless otherwise designated, that is, when the priority of each dimension d is equal, c_{d} of each dimension d is all set to 1, for example. The above is the description of the acquisition function in the present exemplary embodiment and the specific calculation method for the acquisition function.

The calculation method for the acquisition function described above is a method for obtaining a strict solution, and in particular, in a case where the number of objective characteristics whose optimization objective is minimization is large, there is a possibility that the calculation amount becomes enormous. Therefore, in order to improve calculation efficiency, the acquisition function may be calculated by an approximate method such as a Monte Carlo method. Even in that case, the division of the characteristic space into small regions, the improvement region, and the like are the same as those described above.

[Output]

Evaluation value output unit 13 acquires evaluation value data 224 indicating the evaluation value of each candidate experimental point calculated as described above by evaluation value calculator 12, and causes display 104 to display evaluation value data 224. Evaluation value output unit 13 may directly acquire evaluation value data 224 from evaluation value calculator 12, or may acquire evaluation value data 224 by reading evaluation value data 224 stored in storage 105 by evaluation value calculator 12.

FIG. 16 is a view illustrating an example of evaluation value data 224. For example, as illustrated in FIG. 16, evaluation value data 224 indicates the evaluation value and its rank at each candidate experimental point. Specifically, evaluation value data 224 indicates, for each experimental point number, the evaluation value corresponding to the experimental point number and the rank of the evaluation value. As illustrated in FIGS. 10A and 10B, each experimental point number is associated with a candidate experimental point. Therefore, it can be said that evaluation value data 224 indicates, for each candidate experimental point, the evaluation value corresponding to the candidate experimental point and the rank of the evaluation value. The larger the evaluation value is, the smaller numerical value the rank shows, and conversely, the small the evaluation value is, the larger numerical value the rank shows.

In a specific example, as illustrated in FIG. 16, evaluation value data 224 indicates an evaluation value “0.00000” and a rank “23” corresponding to the experimental point number “1”, an evaluation value “0.87682” and a rank “1” corresponding to the experimental point number “2”, an evaluation value “0.62342” and a rank “4” corresponding to the experimental point number “3”, and the like.

Displaying of such evaluation value data 224 on display 104 allows the user to judge whether to continue or end the search for the optimal solution. When continuing the search for the optimal solution, the user can select a candidate experimental point to be the next experimental point from all the displayed experimental point numbers, that is, all the candidate experimental points, based on each displayed evaluation value and each rank. For example, the user selects the candidate experimental point corresponding to the largest evaluation value (that is, the evaluation value whose rank is 1). At this time, the user may perform an input operation on input unit 101a to sort the evaluation values of evaluation value data 224 in descending order. That is, evaluation value output unit 13 sorts the evaluation values and the ranks in evaluation value data 224 such that the evaluation values are in descending order and the ranks are in ascending order. This makes it easy to find the largest evaluation value.

As described above, reception controller 10 in the present exemplary embodiment acquires experimental result data 222, objective data 212, and constraint condition data 213. Evaluation value calculator 12 calculates the evaluation value of an unknown characteristic point based on experimental result data 222, objective data 212, and constraint condition data 213, and evaluation value output unit 13 outputs the evaluation value. Here, evaluation value calculator 12 gives weighting according to the degree of compatibility of the constraint condition to the evaluation value for at least one objective characteristic. Due to this, when evaluation value calculator 12 calculates the evaluation value of an unknown characteristic point based on experimental result data 222, objective data 212, and constraint condition data 213, weighting according to the degree of compatibility of the constraint condition is given to the evaluation value for at least one objective characteristic. This at least one objective characteristic has an optimization objective. Therefore, it is possible to apply Bayesian optimization to an optimization problem in which a constraint condition is given to an objective characteristic having an objective of the optimization problem. As a result, it is possible to extend the application scene.

In the present exemplary embodiment, the constraint condition is a standard range, and the optimization objective includes the first objective of keeping the objective characteristic within the standard range and the second objective of minimizing or maximizing the objective characteristic. Then, for each of at least one objective characteristic, evaluation value calculator 12 calculates the evaluation value by performing weighting processing different from one another among (i) a case where the interval of the objective characteristic used for calculating the evaluation value is out of the standard range, (ii) a case where the interval is within the standard range and the optimization objective is the first objective, and (iii) a case where the interval is within the standard range and the optimization objective is the second objective. That is, the evaluation value is calculated based on (Formula 4) and (Formula 5) described above. Due to this, regardless of whether the optimization objective of the objective characteristic is the first objective or the second objective, the evaluation value of the candidate experimental point can be appropriately calculated based on Bayesian optimization. That is, the evaluation value of the candidate experimental point can be appropriately calculated based on Bayesian optimization, regardless of whether the optimization objective of the objective characteristic is within the standard range or maximization or minimization. In the case of (iii), since the interval of the objective characteristic is within the standard range and the optimization objective is the second objective, unlike the method of NPL 2, the evaluation value can be quantitatively and appropriately calculated even in a case where the objective characteristic whose optimization objective is maximization or minimization has a standard range as a constraint condition.

As a result, it is possible to apply the present disclosure also to an optimization problem having a constraint condition such as a standard range. That is, it is possible to extend the application scene, and perform quantitative evaluation for improving the search efficiency of the optimal solution.

Evaluation value calculator 12 gives priority to each of at least one objective characteristic such as c_{d} in (Formula 5), and calculates the evaluation value of each candidate experimental point using the given priority. Due to this, since one or more objective characteristics are given priority, the objective characteristic given high priority can be brought close to the optimization objective earlier than the objective characteristic given low priority.

Evaluation value calculator 12 may calculate the evaluation value of each candidate experimental point using a Monte Carlo method. Due to this, since the Monte Carlo method is an approximation method, the processing load for calculation of the evaluation value can be reduced. Specifically, evaluation value calculator 12 calculates the sum of expectation values of the volumes of the small regions determined by (Formula 5) for each small region for arithmetic operation of (Formula 4). Therefore, for example, in a case where the number of small regions is large, a large calculation amount is required for the arithmetic operation of (Formula 4). Therefore, the processing load can be reduced by using the Monte Carlo method without strictly performing the arithmetic operation of (Formula 4). As long as an approximation method is used, not only the Monte Carlo method but also another method may be used.

(First Modification)

In the above-described exemplary embodiment, the standard range is provided as a constraint condition. In the present modification, not only the standard range but also a range other than the standard range is provided. For example, a case where a management range in which the characteristic point is desired to fall as much as possible is set in a standard range in which the characteristic point is desired to fall at the very least is also often required in practice. Each of the standard range and the management range is an example of a constraint range that is a constraint condition.

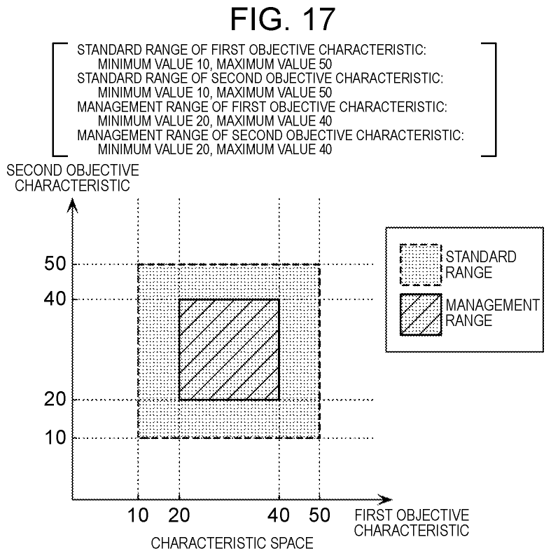

FIG. 17 is a view illustrating an example of a standard range and a management range.

For example, the standard range of the first objective characteristic is from the minimum value “10” to the maximum value “50”, and the standard range of the second objective characteristic is from the minimum value “10” to the maximum value “50”. The management range of the first objective characteristic is a range narrower than the standard range, that is, from the minimum value “20” to the maximum value “40”, and the management range of the second objective characteristic is a range narrower than the standard range, that is, from the minimum value “20” to the maximum value “40”. As described above, the management range is included in the standard range.

In such a case, evaluation value calculator 12 calculates the evaluation value by further setting an intermediate value such as 0.5 present between 0 and 1 for 1(yd, yd′) as in following (Formula 6). 0.5 is an example, and may be another numerical value.

$$[ Mathematical expression 6 ]$$

$$l ( {y}_{d} , {y}_{d}^{′} ) = \{ \begin{matrix}0 & ( i ) \\ 0.5 & ( ii ) \\ 1 & ( iii ) \\ ( {y}_{d} - {y}_{d}^{′} ) & ( iv )\end{matrix} \qquad ( Formula 6 )$$

(i) in (Formula 6) is applied when the interval [y_{d}, y_{d}′] is out of each of the management range and the standard range regarding dimension d. (ii) is applied when the interval [y_{d}, y_{d}′] is within the standard range and out of the management range regarding dimension d, and the optimization objective of the objective characteristic of dimension d is within the constraint range. (iii) is applied when the interval [y_{d}, y_{d}′] is within the management range regarding dimension d, and the optimization objective of the objective characteristic of dimension d is within the constraint range. (iv) is applied when the interval [y_{d}, y_{d}′] is within the management range regarding dimension d, and the optimization objective of the objective characteristic of dimension d is minimization.

As described above, in the present modification, in a case where a plurality of constraint ranges are provided as the constraint condition, the number of case classifications is increased according to those constraint ranges, and weighting processing different from one another is performed in those cases. That is, when there are a plurality of constraint ranges as the constraint condition, evaluation value calculator 12 further divides the case of (ii) in (Formula 5) into a plurality of cases such as in the case of (ii) and the case of (iii) in (Formula 6), and calculates the evaluation value by performing weighting processing different from one another among the plurality of cases. In each of the plurality of cases, intervals are included in constraint ranges different from one another among the plurality of constraint ranges. For example, as in (ii) and (iii) in (Formula 6), in the case of (ii), the interval is included in the standard range out of the management range, and in the case of (iii), the interval is included in the management range. Thus, when there are a plurality of constraint ranges, and by further dividing the case (ii) into a plurality of cases, it is possible to perform weighting on each of the plurality of constraint ranges in a stepwise manner. Therefore, it is possible to appropriately calculate the evaluation value even in a case where the value of the objective characteristic falls within the standard range and is desired to fall within the management range as much as possible. That is, the acquisition function can be appropriately applied to the practical requirements as described above. As a result, it is possible to further extend the application scene for the optimization problem.

The standard range used for the condition for case classification of (i) to (iv) in (Formula 6) above may be replaced with the management range, and conversely, the management range may be replaced with the standard range. The present modification uses the standard range and the management range each as an example of the constraint range, but constraint ranges other than these may be used. That is, three or more constraint ranges may be used. The shapes of the plurality of constraint ranges may be the same or different from one another. The shapes may be any shape such as a rectangle, a circle, an ellipse, or a star. The present modification has an inclusion relationship in a plurality of constraint ranges as the standard range includes the management range, but the present disclosure is not limited to such an inclusion relationship, and the respective constraint ranges may be separated from one another, and only a part of the respective constraint ranges may overlap one another.

As in the above-described exemplary embodiment and the present modification, the present disclosure is only required to have at least one constraint range. Therefore, the standard ranges used for the conditions in the cases (i) to (iii) in (Formula 5) described above and the first objective may be replaced with any constraint range of the at least one constraint range. The constraint ranges used for the conditions in each of the cases (i) to (iii) in (Formula 5) described above and the first objective may be the same constraint ranges or may be constraint ranges different from one another.

(Second Modification)

In the above-described exemplary embodiment, evaluation value calculator 12 calculates the evaluation value. Evaluation value calculator 12 in the present modification calculates not only the evaluation value but also a minimum distance. The minimum distance is the smallest distance of the distances between the candidate experimental points and respective experimental points already used in the experiment.

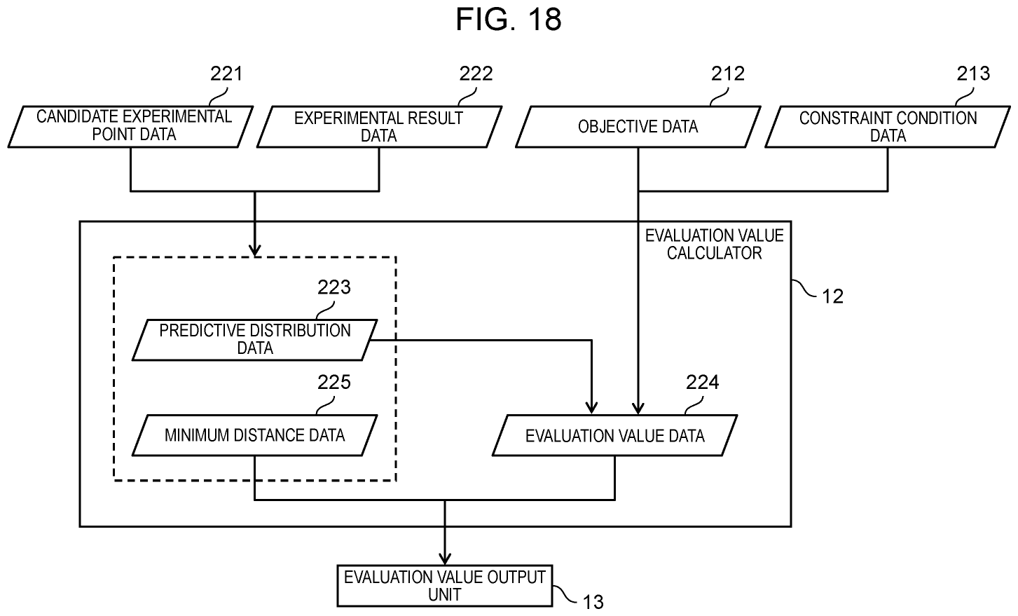

FIG. 18 is a view for explaining the processing by evaluation value calculator 12 in the present modification.

Evaluation value calculator 12 calculates the minimum distance of candidate experimental points based on candidate experimental point data 221 and experimental result data 222. This minimum distance is, as described above, the smallest distance of the distances on the experimental space between the candidate experimental point and each of at least one experimental point already used in the experiment. Then, evaluation value calculator 12 generates minimum distance data 225 indicating the minimum distance of candidate experimental points. Evaluation value calculator 12 outputs evaluation value data 224 to evaluation value output unit 13 as in the above-described exemplary embodiment, and also outputs minimum distance data 225 to evaluation value output unit 13. Evaluation value calculator 12 may store minimum distance data 225 into storage 105, and evaluation value output unit 13 may read minimum distance data 225 from storage 105 in response to an input operation to input unit 101a by the user.

Using Lp distance or the like as in following (Formula 7), for example, evaluation value calculator 12 may calculate the distance between the candidate experimental point and the experimental point already used in the experiment.

$$[ Mathematical expression 7 ]$$

$$Lp ( x , {x}^{′} ) \{ \begin{matrix}= \sqrt[p]{{\sum }_{i = 1}^{D} {\vert {x}_{i} - {x}_{i}^{′} \vert}^{p}} & ( p > 0 ) \\ \begin{matrix}= Number of non - zero \\ elements of ( x - {x}^{′} )\end{matrix} & ( p = 0 )\end{matrix} \qquad ( Formula 7 )$$

In (Formula 7), D represents the number of control factors, one of x and x′ represents the candidate experimental point, and the other represents the experimental point already used in the experiment. When p=2, Lp(x, x′) indicates a Euclidean distance (that is, straight line distance), and when p=1, Lp(x, x′) indicates a Manhattan distance (that is, journey distance). When p=0, Lp(x, x′) indicates the number of different level factors, and when p=∞, Lp(x, x′) indicates the maximum level difference.

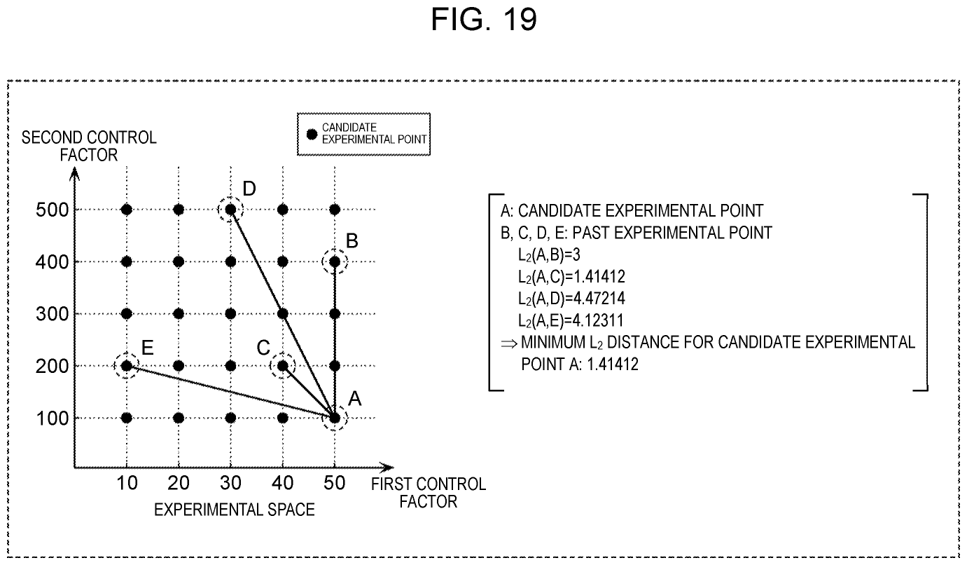

FIG. 19 is a view illustrating an example of the minimum distance.

For example, as illustrated in FIG. 19, evaluation value calculator 12 calculates the Lp distance (that is, L₂ distance) in a case where p=2. In the case of the example illustrated in FIG. 19, in the experimental space, evaluation value calculator 12 calculates L₂ distance between candidate experimental point A and each of experimental points B, C, D, and E that are candidate experimental points already used in the experiment. For example, evaluation value calculator 12 calculates L₂(A, B)=3 as the L₂ distance between candidate experimental point A and experimental point B, and calculates L₂(A, C)=1.41412 as the L₂ distance between candidate experimental point A and experimental point C. Similarly, evaluation value calculator 12 calculates L₂(A, D)=4.47214 as the L₂ distance between candidate experimental point A and experimental point D, and calculates L₂(A, E)=4.12311 as the L₂ distance between candidate experimental point A and experimental point E. Then, evaluation value calculator 12 decides “1.41412”, which is the minimum distance of these L₂ distances, as the minimum L₂ distance. In the example of FIG. 19, evaluation value calculator 12 sets the minimum value of the difference between the two values in each control factor to the reference distance 1 and calculates the Lp distance so that the distance does not depend on the scale of each control factor.

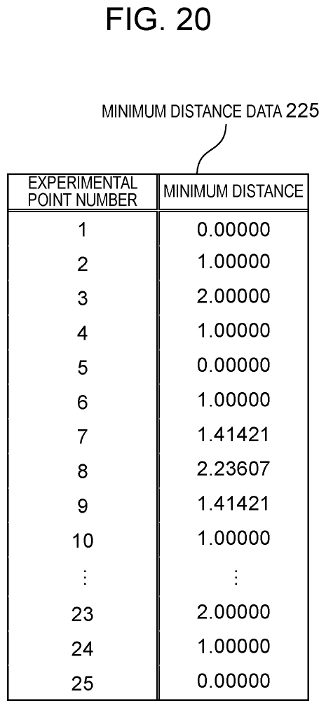

FIG. 20 is a view illustrating an example of minimum distance data 225.

Minimum distance data 225 indicates, for each experimental point number, the minimum distance corresponding to the experimental point number. As illustrated in FIGS. 10A and 10B, each experimental point number is associated with a candidate experimental point. Therefore, it can be said that minimum distance data 225 indicates, for each candidate experimental point, the minimum distance corresponding to the candidate experimental point.

In a specific example, as illustrated in FIG. 20, minimum distance data 225 indicates a minimum distance “0.00000” corresponding to the experimental point number “1”, a minimum distance “1.00000” corresponding to the experimental point number “2”, a minimum distance “2.00000” corresponding to the experimental point number “3”, and the like. The candidate experimental point of the experimental point number corresponding to the minimum distance “0.00000” is an experimental point already used in the experiment.

By including the content of minimum distance data 225 into evaluation value data 224, evaluation value output unit 13 may change evaluation value data 224 and display changed evaluation value data 224 onto display 104.

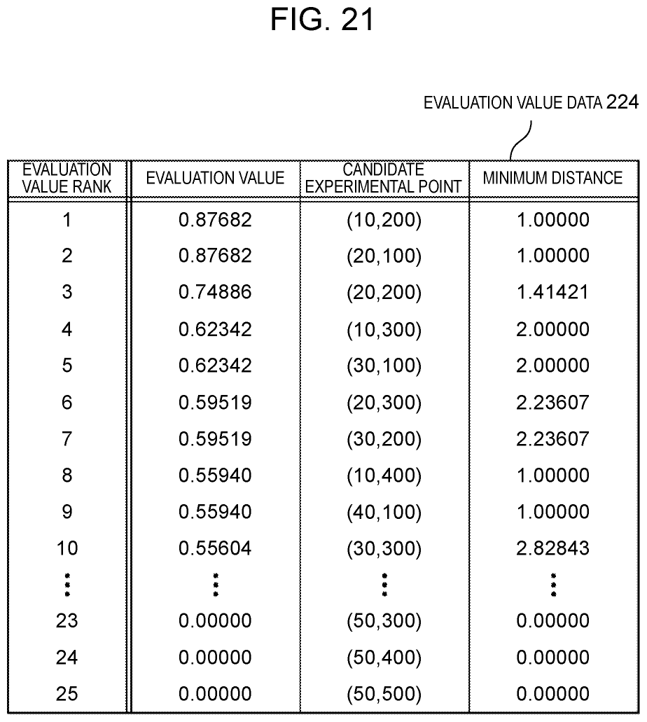

FIG. 21 is a view illustrating an example of changed evaluation value data 224 displayed on display 104.

For example, as illustrated in FIG. 21, changed evaluation value data 224 indicates, for each rank of the evaluation values, the evaluation value corresponding to the rank, the candidate experimental point corresponding to the evaluation value, and the minimum distance corresponding to the candidate experimental point. The rank of the evaluation values is arranged in ascending order. That is, the candidate experimental points are arranged in descending order of the evaluation value. For example, evaluation value data 224 indicates an evaluation value “0.87682” corresponding to the rank “1”, a candidate experimental point (10, 200) corresponding to the evaluation value, and a minimum distance “1.00000” corresponding to the candidate experimental point. Evaluation value data 224 indicates an evaluation value “0.87682” corresponding to the rank “2”, a candidate experimental point (20, 100) corresponding to the evaluation value, and a minimum distance “1.00000” corresponding to the candidate experimental point.

Displaying of such evaluation value data 224 on display 104 allows the user to judge whether to continue or end the search for the optimal solution. When continuing the search for the optimal solution, the user selects the next experimental point from one or more candidate experimental points indicated in evaluation value data 224. Here, in the present modification, the user decides the next experimental point based on the evaluation value and the minimum distance. Specifically, the user decides a candidate experimental point of a basically large evaluation value as the next experimental point. However, at a stage where the number of experimental results is small in particular, evaluation values of candidate experimental points close to past experimental points, such as candidate experimental points near the experimental point with the best score in the past experimental results, tend to appear in the upper rank. Even if the experiment is executed at such a candidate experimental point, there is a high possibility that a characteristic point with a large improvement amount cannot be obtained. In a case where it is desired to select a plurality of experimental points to perform batch processing, when experimental points with a distance far from each other are selected, accuracy of a predictive distribution and an evaluation value to be calculated next is easily improved. Therefore, the user preferably refers to the minimum distance in addition to the evaluation value as a criterion for decision of the next experimental point.

The user may refer to the evaluation value and the minimum distance as a criterion for judgement whether to continue or end the search for the optimal solution. For example, in a case where all the candidate experimental points whose evaluation values are non-zero exist near the executed experimental point, and all the evaluation values of the candidate experimental points far from the executed experimental point are almost 0, no improvement is expected even if the experiment is continued further. Therefore, in such a case, the user preferably ends the search.

As described above, evaluation value calculator 12 in the present modification calculates, for each candidate experimental point, the minimum distance of the distances between the candidate experimental point and respective one or more experimental points Evaluation value output unit 13 outputs the minimum distance corresponding to each candidate experimental point. This allows the user of evaluation device 100 to select a candidate experimental point to be the next experimental point based on not only the evaluation value but also the minimum distance. For example, at the initial stage of optimal solution search, the user can improve the accuracy of the evaluation value and perform appropriate optimization by selecting, as the next experimental point, a candidate experimental point corresponding to an evaluation value having a relatively large evaluation value and a relatively long minimum distance.

(Other Modifications)

While evaluation device 100 according to one aspect of the present disclosure has been described above based on the above-described exemplary embodiment and each modification, the present disclosure is not limited to the exemplary embodiment and each modification. The present disclosure may include various modifications conceivable by those skilled in the art may be applied to the above-described exemplary embodiment or each modification described above without departing from the scope of the present disclosure.

For example, in the above-described exemplary embodiment and each modification, evaluation value calculator 12 calculates the evaluation value using EHVI based on expected improvement (EI), but may calculate the evaluation value using probability of improvement (PI). That is, in the above-described exemplary embodiment, the evaluation value is calculated by application of EHVI as in (Formula 4) and (Formula 5). However, the evaluation value may be calculated by application of PI. When PI is used, evaluation value calculator 12 calculates the evaluation value using following (Formula 8) instead of (Formula 5).

$$[ Mathematical expression 8 ]$$

$$( Volume of small region ) = {\prod }_{d = 1}^{D} {c}_{d} \times l ( {y}_{d} , {y}_{d}^{′} ) \\ l ( {y}_{d} , {y}_{d}^{′} ) = \{ \begin{matrix}0 & ( i ) \\ 1 & ( ii ) \\ 1 & ( iii )\end{matrix} \qquad ( Formula 8 )$$

Similarly to EHVI, evaluation value calculator 12 calculates the evaluation value by performing expectation value processing on the volume calculated by (Formula 8). The case classification conditions of (i) to (iii) in (Formula 8) are the same as those in (Formula 5). Calculation of the evaluation value using PI and calculation of the evaluation value using EI may be combined. For example, PI may be used for the first objective characteristic, and EI may be used for the second objective characteristic.

In this manner, evaluation value calculator 12 of the present disclosure calculates the evaluation value of each candidate experimental point using at least one of PI and EI, which are evaluation methods. Due to this, for each candidate experimental point, it is possible to calculate, as an optimization improvement amount, the volume within the constraint range in a characteristic space, and appropriately calculate the evaluation value from the improvement amount.

In the above-described exemplary embodiment, the case where the number of dimensions of the objective characteristic is two as in the first objective characteristic and the second objective characteristic has been described, but the number of dimensions may be one or three or more. Similarly, in the above-described exemplary embodiment, the case where the total number of control factors is two, such as the first control factor and the second control factor, has been mainly described, but the total number may be one or three or more.

In the above-described exemplary embodiment, each constituent element may be configured with dedicated hardware or may be implemented by executing a software program individually suitable for those constituent elements. Each constituent element may be implemented by a program executor such as a CPU or a processor reading and executing a software program recorded in a recording medium such as a hard disk or a semiconductor memory. Here, the software that implements the evaluation device and the like of the above-described exemplary embodiment is a program that causes a computer to execute each step of the flowchart illustrated in FIG. 9, for example.

The following cases are also included in the present disclosure.

(1) The at least one device is a computer system specifically including a microprocessor, a read only memory (ROM), a random access memory (RAM), a hard disk unit, a display unit, a keyboard, and a mouse. The RAM or the hard disk unit stores a computer program. By the microprocessor operating in accordance with the computer program, the at least one device achieves its functions. Herein, the computer program includes a combination of a plurality of command codes that indicate instructions to the computer, in order to achieve predetermined functions.

(2) A part or all of the constituent elements constituting the at least one device may include one system large scale integration (LSI). The system LSI is a super multifunctional LSI manufactured by integrating a plurality of components on one chip, and is specifically a computer system configured to include a microprocessor, a ROM, and a RAM. The RAM stores a computer program. By the microprocessor operating in accordance with the computer program, the system LSI achieves its functions.

(3) A part or all of the constituent elements constituting the at least one device may include an IC card detachable from the device or a single module. The IC card or the module is a computer system including a microprocessor, a ROM, and a RAM. The IC card or the module may include the above-described super multifunctional LSI. By the microprocessor operating in accordance with the computer program, the IC card or the module achieves its function. This IC card or this module may have tamper resistance.

(4) The present disclosure may be the methods described above. The present disclosure may be a computer program that causes a computer to implement these methods, or may be a digital signal configured of the computer program.

The present disclosure may be a computer program or a digital signal recorded in a computer-readable recording medium such as a flexible disk, a hard disk, a compact disc (CD)-ROM, a DVD, a DVD-ROM, a DVD-RAM, a Blu-ray (registered trademark) disc (BD), or a semiconductor memory. Moreover, the present disclosure may be a digital signal recorded in these recording media.

The present disclosure may be a computer program or a digital signal transmitted via an electric communication line, a wireless or wired communication line, a network represented by the Internet, data broadcasting, or the like.

The present disclosure may be carried out by another independent computer system by recording, on a recording medium, and transferring a program or a digital signal, or by transferring a program or a digital signal via a network or the like.

The evaluation device of the present disclosure achieves an effect of being capable of apply Bayesian optimization to an optimization problem in which a constraint condition is given to an objective characteristic having an objective of the optimization problem, and can be applied not only to industrial product development or manufacturing process development but also to a device or system of optimal control in general development work such as material development.

What is claimed is:

1. An evaluation device that evaluates, by Bayesian optimization, an unknown characteristic point corresponding to a candidate experimental point based on a known characteristic point corresponding to an experimented experimental point, the evaluation device comprising:
a first receiver that acquires experimental result data indicating the experimented experimental point and the known characteristic point;
a second receiver that acquires objective data in which the unknown characteristic point indicates one or a plurality of objective characteristics, and at least one objective characteristic has an optimization objective and indicates the optimization objective;
a third receiver that acquires constraint-condition data indicating a constraint condition given to the at least one objective characteristic;
a calculator that calculates an evaluation value of the unknown characteristic point based on the experimental result data, the objective data, and the constraint-condition data; and
an output unit that outputs the evaluation value,
wherein the calculator gives weighting according to a degree of compatibility of the constraint condition to an evaluation value for the at least one object characteristic.

2. The evaluation device according to claim 1, wherein
the constraint condition is at least one constraint range,
the optimization objective includes a first objective of keeping an objective characteristic within any constraint range of the at least one constraint range and a second objective of minimizing or maximizing an objective characteristic, and
for each of the at least one objective characteristic,
the calculator calculates the evaluation value by performing weighting processing different from one another among
(i) a case where an interval of the objective characteristic used for calculating the evaluation value is out of each of the at least one constraint range,
(ii) a case where the interval is within any constraint range of the at least one constraint range, and the optimization objective is the first objective, and
(iii) a case where the interval is within any constraint range of the at least one constraint range, and the optimization objective is the second objective.

3. The evaluation device according to claim 2, further comprising a candidate experimental point creation unit that creates the candidate experimental point by combining values that satisfy predetermined conditions of a plurality of control factors.

4. The evaluation device according to claim 2, wherein
the calculator calculates the evaluation value based on a constraint range having a shape different from a rectangle of the at least one constraint range.

5. The evaluation device according to claim 2, wherein
the at least one constrained range comprises a plurality of constraint ranges,
the calculator further divides the case (ii) into a plurality of cases, and calculates the evaluation value by performing weighting processing different from one another among the plurality of cases, and
in each of the plurality of cases, the interval is included in constraint ranges different from one another among the plurality of constraint ranges.

6. The evaluation device according to claim 1, wherein
the calculator
gives priority to each of the at least one objective characteristic, and
calculates the evaluation value using the priority having been given.

7. The evaluation device according to claim 1, wherein
the calculator further calculates a minimum distance of distances between the candidate experimental point and respective one or more of the experimented experimental points, and
the output unit further outputs the minimum distance corresponding to the candidate experimental point.

8. The evaluation device according to claim 1, wherein
the calculator calculates the evaluation value using a Monte Carlo method.

9. The evaluation device according to claim 1, wherein
the calculator calculates the evaluation value using at least one of probability of improvement (PI) and expected improvement (EI), each of which is an evaluation method.

10. An evaluation method for an evaluation device to evaluate, by Bayesian optimization, an unknown characteristic point corresponding to a candidate experimental point based on a known characteristic point corresponding to an experimented experimental point, the evaluation method comprising:
first receiving of acquiring experimental result data indicating the experimented experimental point and the known characteristic point;
second receiving of acquiring objective data in which the unknown characteristic point indicates one or a plurality of objective characteristics, and at least one objective characteristic has an optimization objective and indicates the optimization objective;
third receiving of acquiring constraint-condition data indicating a constraint condition given to the at least one objective characteristic;
calculating an evaluation value of the unknown characteristic point based on the experimental result data, the objective data, and the constraint-condition data; and
outputting the evaluation value,
wherein in the calculating, weighting according to a degree of compatibility of the constraint condition is given to an evaluation value for the at least one object characteristic.

11. A non-transitory recording medium that stores a program for evaluating, by Bayesian optimization, an unknown characteristic point corresponding to a candidate experimental point based on a known characteristic point corresponding to an experimented experimental point, the program causes a computer to execute:
first receiving of acquiring experimental result data indicating the experimented experimental point and the known characteristic point;
second receiving of acquiring objective data in which the unknown characteristic point indicates one or a plurality of objective characteristics, and at least one objective characteristic has an optimization objective and indicates the optimization objective;
third receiving of acquiring constraint-condition data indicating a constraint condition given to the at least one objective characteristic;
calculating an evaluation value of the unknown characteristic point based on the experimental result data, the objective data, and the constraint-condition data; and
outputting the evaluation value,
wherein in the calculating, weighting according to a degree of compatibility of the constraint condition is given to an evaluation value for the at least one object characteristic.
